(19) United States
(12) Patent Application Publication
(10) Pub. No.: US 2007/0095823 A1
(43) Pub. Date: May 3, 2007

(54) Microwave nucleon-electron-bonding spin alignment and alteration of materials

(76) Inventor: Steven R. Sedlmayr, Paradise Valley, AZ (US)

Correspondence Address: STEVEN R. SEDLMAYR, 6538 N. 41ST STREET, PARADISE WAY, AZ, 85253, US

(21) Appl. No.: 11/506,366

(22) Filed: Aug. 17, 2006

Related U.S. Application Data
(60) Provisional application No. 60/730,789, filed on Oct. 27, 2005.

(51) Int. Cl. H05B 6/72; H05B 6/80

(52) U.S. Cl. 219/688; 219/748

(57) ABSTRACT

A microwave energy emitter (108) is positioned in a microwave transparent chamber (123) within a material holding vessel (106) of a microwave containment vessel (122). The holding vessel (106) may be transparent to microwave energy and is further provided with a microwave reflective component outward, on, or beyond an exterior surface (121) of the wall of the holding vessel (106). The microwave reflective component reflects microwaves back into the fluid holding vessel (106). The fluid holding vessel (106) encloses a material that absorbs microwave energy. An inlet path (116) and outlet path (112) is provided for the material to flow in and out of the vessel upon predetermined conditions. Heated material can be condensed via a condenser (124) into a collection vessel (120). A controller (126) is provided to send control signals to a switching device (100) for controlling the material flow and receiving sensing signals for decision generation.

### CROSS REFERENCE TO RELATED APPLICATIONS

This application claims the benefit of provisional patent application 60/730,789, filed Oct. 27, 2005, herein incorporated by reference. patent application Ser. No. 11/051, 671, patent application Ser. No. 11/051,672, and patent application Ser. No. 11/482,396 are herein incorporated by reference.

### FEDERALLY SPONSORED RESEARCH

Not Applicable

### SEQUENCE LISTING OR PROGRAM

Not Applicable

### BACKGROUND OF THE INVENTION

I have invented a new apparatus, machine, and method for the heating of fluids via microwave frequencies induced into the material to be heated. The process began by trying to invent a better water distiller and purification system than the current one I am using at home. The unit I currently utilize for home has electrodes in a boiling chamber and the electrodes corrode because of the impurities in the water that supplies the house. This started me thinking how I might create a unit that would not have components that corrode because of the corrosive action of water in contact with metallic parts. To attempt a cure for this problem with the current home unit that is now being used I have installed several water conditioning units in front of it, including carbon filters and reverse osmosis filters. However this water is more “aggressive” and the units' electrodes seem to break down more rapidly and had more failures. The water purification process of the machine with electrodes heating the water is comparatively slow with the machine taking 24 hours or more to make 8 gallons of water and power intensive. The distilled water made is used mainly for drinking and cooking, as the replenishment times are prohibitively slow for other high volume usages.

Since I did not want the process to involve corrosion it seemed to me that a new way of boiling or heating water was necessary. I knew that a microwave oven could boil water but after doing the research found out that microwave ovens create “super heated water” and that boiling or steaming water was a problem in a microwave oven. I also did not want to cause microwaves to be injected into a cavity with another container in the cavity, as this seems to be a waste of power and efficiency because of the difference in the cavity geometries. This method has been utilized in U.S. Pat. No. 6,015,968 Armstrong, U.S. Pat. No. 5,711,857 Armstrong, U.S. Pat. No. 5,286,939 Martin, U.S. Pat. No. 4,694,133 Le Viet, and other patents mentioned in my patents examined further in this document. I then had the idea of building the antenna into the middle of the cavity, which held the fluid to be heated with the cavity being the wave-guide. The concept of having a remote antenna inserted into a vessel is mentioned in U.S. Pat. No. 6,175,104 Greene et al. The problem with the '104 patent is that the antenna, or emitting device, is in direct contact with the fluid to be heated. As a result of using a material that was transparent to the microwaves I could design and build a device that can have an antenna physically isolated from the cavity for water heating by an isolated space that consists of a chamber located in the cavity, the antenna located in the chamber with the chamber located within the space of the cavity, and cause the fluid (or material) to be heated without any direct contact by using the cavity as a wave guide/resonance chamber. This also causes the material or fluid surrounding the cavity into which the antenna or microwave emitting device is located to be evenly irradiated by the microwaves. The chamber located in the cavity forms an isolated space from the material that is surrounding it with the inside of the chamber for the antenna, which is isolated from the material in the cavity. Another embodiment could have this cavity sealed itself, with a material held within to act like an emitting antenna, with the microwave signal injected into the material of the chamber in the cavity. The chamber in the cavity is through a wall of the cavity and forms a space isolated from the space of the cavity by a wall of the chamber. Another embodiment could have the material within this isolated space receive the microwaves from the antenna by being a microwave absorber. It would then heat up and cause the material in the vessel to heat up.

Others have proposed building microwave fluid heaters with their design entailing the conventional use of a microwave generator device located off to one side of the cavity or built into the side of the cavity, as in U.S. Pat. No. DES 293,128 Karamian, U.S. Pat. No. DES 293,368 Karamian, U.S. Pat. No. 6,015,968 Armstrong, U.S. Pat. No. 4,671,951 Masse, U.S. Pat. No. 4,671,952 Masse, U.S. Pat. No. 4,694,133 Le Viet, U.S. Pat. No. 4,778,969 Le Viet, U.S. Pat. No. 4,417,116 Black, U.S. Pat. No. 5,387,780 Riley. They typically use wave-guides to direct the microwaves from the source into the cavity containing the water or fluid to be heated or steamed. This invention uses the direct output from the microwave source or antenna to heat the fluid.

Another problem with heating water in a microwave and with microwaves is the super heated water problem. That is, water will heat to over the boiling temperature of water at sea level of 100° C. without boiling, or going into steam. As pointed out in the article Ask a Scientist, Chemistry Archive, SuperHeated Water, by the USA Department of Energy, incorporated herein by reference; obtained from the internet, water heated in a microwave in a cup will superheat the water, but will not cause it to steam. A boiling point must be established for other water molecules to boil. From the above article “Boiling begins at a temperature when the vapor pressure of a liquid equals the ambient atmospheric pressure that is above the pool of liquid. However, you will not have boiling water if there are no sites for the vapor (within the liquid) to nucleate (grow) from. Good nucleating sites are scratches, irregularities and other imperfections inside the cup, mug, or in your case the Pyrex. Thus, when a fork is put into a cup, the super heated water then explosively boils and steams vigorously.”

This is also a problem with very smooth glass, such as a Pyrex bowl, and presents a technical barrier to be solved in the invention that I have outlined using a Pyrex boiling/wave guide chamber. One solution is to make the Pyrex chamber side walls uneven and rough, while another solution is causing the fluid or matter in the chamber to be stirred by an internal force, such as a fan, or an external stimulation, such as an ultrasonic transducer or even low frequency waves, or a device that rotates when the electric field is applied due to EMF forces. This is a problem when trying to heat a fluid to a boiling point and above to produce vapor or steam. It further helps the thermal distribution through out the mixture by causing a stirring of the mixture that will even out the heating throughout the fluid or material being heated.

### BACKGROUND OF THE INVENTION-OBJECTS AND ADVANTAGES

This invention is superior to other microwave fluid heaters because:
It does not use a vessel that is impervious to corrosion or degradation because of chemical reaction in the presence of heated fluid
The microwave generator is surrounded by the medium to be heated and does not have any power loss due to coupling through wave guides delivering the microwaves to the medium to be heated
It is very inexpensive to build
It reduces power consumption by large efficiencies
It can be scaled in size from very small to very large
It heats the medium to be heated very quickly
It can be used to purify water or other fluids inexpensively
The microwave generator can be replaced quickly and inexpensively to renew or replenish the device
It can generate extremely pure water without contaminates
It can adapt its efficiency to the medium it is trying to heat
It reduces pollution
It can be used to heat water or other fluids
It can be made small enough to be portable
It is one of only a few viable ways to destroy estrogenic contaminates in water
The microwaves directly irradiate the source, destroying bacteria and viruses that are susceptible to the wave length of the microwaves and the heat of the fluid
This invention allows the material to surround the microwave source and be more evenly radiated than other inventions
An object of the invention is to provide cleaner and safer water.
An object of the invention is to provide and apparatus and method for producing heavy water
An object of the invention is to provide an apparatus and method for producing cold fusion
An object of the invention is to provide an apparatus and method for producing hydrogen gas
An object of the invention is to provide an apparatus and method for producing water for the cosmetic industry
An object of the invention is to provide an apparatus and method for producing super conducting metals and materials at room temperature.
An object of the invention is to provide an apparatus and method for producing hydrogen/oxygen separation.
An object of the invention is to provide an apparatus and method for producing molecular spin-aligned materials
An object of the invention is to provide an apparatus and method for producing molecular spin-aligning the molecules for semiconductor materials
An object of the invention is to produce faster microprocessors
An object of the invention is to produce faster electronic components
An object of the invention is to produce water that will remove some of the effects of aging on the face
An object of the invention is to produce water that will help reduce or kill some forms of melanoma and other cancers or skin tumors or lesions
An object of this invention is to facilitate the manufacturing of materials to be used in cold fusion.
An object of this invention is to make a better and faster curing concrete through a distillate of this invention used with a standard concrete mixture.
An object of this invention is to make a better and faster rising bread mixture through a distillate of this invention used with a standard bread mixture.
An object of this invention is to make a better and faster curing beer through a distillate of this invention used with a standard beer mixture.
An object of this invention is to make a better and faster curing wine through a distillate of this invention used with a standard wine mixture.
An object of this invention is to make a better and faster curing plaster through a distillate of this invention used with a standard plaster mixture.
An object of this invention is to make a better and faster curing pasta through a distillate of this invention used with a standard pasta mixture.
An object of this invention is to make a better and faster curing flour mixture through a distillate of this invention used with a standard flour mixture.
An object of this invention is to make a better and faster curing glue through a distillate of this invention used with a standard glue mixture.
An object of this invention is to make a better and faster drying paint through a distillate of this invention used with a standard paint mixture.
An object of this invention is to make a better and faster curing ink through a distillate of this invention used with a standard ink mixture.
An object of this invention is to produce a distillate that can be used in the cosmetic industry for facial products.
An object of this invention is to produce a distillate for use in any industry that requires water in the process to manufacture a product.
An object of this invention is a device for producing heavy water by microwave energy, said device comprising: a microwave containment vessel having a material holding vessel, with a wall having an exterior surface and an interior surface defining a cavity, an antenna chamber formed in and providing isolation from the material holding vessel the antenna chamber being transparent to microwaves and protruding through the material holding vessel wall and located in the middle of one of the surfaces of the material holding vessel, a microwave reflector outward of the exterior surface of the wall.
An object of this invention is a method for producing heavy water by microwave energy comprising the acts of: providing a microwave containment vessel having a material holding cavity and an antenna chamber, the antenna chamber formed of a microwave transparent material, and extending through a surface of the microwave containment vessel and into the material holding cavity, and the antenna chamber opening is located in the middle of one of the surfaces of the microwave containment vessel, putting water into the material holding cavity, providing an alpha-emitting radionuclide located with the material holding vessel, providing a microwave source coupled to a microwave antenna that is place in the antenna chamber of the microwave containment vessel, providing a microwave reflector, activating the microwave source to cause the antenna to emit microwaves to heat the material in the material holding cavity, continuing to heat the material in the material holding cavity to generate vapor, passing the vapor through a condensation coil in communication with the containment vessel, and cooling the vapor to form the distillate.
An object of this invention is a method for producing heavy water by microwave energy comprising the acts of: providing a microwave containment vessel having a material holding cavity and an antenna chamber, the antenna chamber formed of a microwave transparent material, and extending through a surface of the microwave containment vessel and into the material holding cavity, and the antenna chamber opening is located along and centered on an axis of the material holding cavity, putting water into the material holding cavity, providing an alpha-emitting radionuclide located with the material holding vessel, providing a microwave source coupled to a microwave antenna that is placed in the antenna chamber of the microwave containment vessel, providing a microwave reflector beyond the interior surface of the material holding cavity, providing a lead shield beyond the microwave reflector, activating the microwave source to cause the antenna to emit microwaves to heat the material in the material holding cavity, continuing to heat the material in the material holding cavity to generate vapor, passing the vapor through a condensation coil in communication with the containment vessel, and cooling the vapor to form the distillate.
An object of this invention is a method of producing a molecular aligned material comprising the acts of: providing a microwave containment vessel having a material holding cavity and an antenna chamber, the antenna chamber formed of a microwave transparent material, and extending through a surface of the microwave containment vessel and into the material holding cavity, putting material into the holding cavity in the molten state, providing a microwave source coupled to a microwave antenna that is placed in the antenna chamber of the microwave containment vessel, providing a microwave reflector beyond the interior surface of the material holding cavity, activating the microwave source to cause the antenna to emit microwaves to heat the material and align the molecular structure of the material in the material holding cavity, continuing to cause the material to be heated and aligned for a predetermined amount of time, cooling the material to from a solid with an aligned molecular structure.
An object of this invention is a method of producing a molecular aligned material comprising the acts of: providing a microwave containment vessel having a material holding cavity and an antenna chamber, the antenna chamber formed of a microwave transparent material, and extending through a surface of the microwave containment vessel and into the material holding cavity, putting material into the holding cavity in the molten state, providing a microwave source coupled to a microwave antenna that is placed in the antenna chamber of the microwave containment vessel, providing a microwave reflector beyond the interior surface of the material holding cavity, activating the microwave source to cause the antenna to emit microwaves to heat the material and align the molecular structure of the material in the material holding cavity, continuing to cause the material to be heated and aligned for a predetermined amount of time, cooling the material to from a solid with an aligned molecular structure wherein the alignment of the molecular structure is the alignment of a plurality of the atom.
An object of this invention is a method of producing a molecular aligned material comprising the acts of: providing a microwave containment vessel having a material holding cavity and an antenna chamber, the antenna chamber formed of a microwave transparent material, and extending through a surface of the microwave containment vessel and into the material holding cavity, putting material into the holding cavity in the molten state, providing a microwave source coupled to a microwave antenna that is placed in the antenna chamber of the microwave containment vessel, providing a microwave reflector beyond the interior surface of the material holding cavity, activating the microwave source to cause the antenna to emit microwaves to heat the material and align the molecular structure of the material in the material holding cavity, continuing to cause the material to be heated and aligned for a predetermined amount of time, cooling the material to from a solid with an aligned molecular structure wherein the alignment of the molecular structure is the alignment of a plurality of the bonds between the electrons and atoms.
An object of this invention is a method of producing a molecular aligned material comprising the acts of: providing a microwave containment vessel having a material holding cavity and an antenna chamber, the antenna chamber formed of a microwave transparent material, and extending through a surface of the microwave containment vessel and into the material holding cavity, putting material into the holding cavity in the molten state, providing a microwave source coupled to a microwave antenna that is placed in the antenna chamber of the microwave containment vessel, providing a microwave reflector beyond the interior surface of the material holding cavity, activating the microwave source to cause the antenna to emit microwaves to heat the material and align the molecular structure of the material in the material holding cavity, continuing to cause the material to be heated and aligned for a predetermined amount of time, cooling the material to from a solid with an aligned molecular structure wherein the alignment of the molecular structure is the alignment of a plurality of the spins of the nucleons of the atoms.
An object of this invention is a method of producing a molecular aligned material comprising the acts of: providing a microwave containment vessel having a material holding cavity and an antenna chamber, the antenna chamber formed of a microwave transparent material, and extending through a surface of the microwave containment vessel and into the material holding cavity, putting material into the holding cavity in the molten state, providing a microwave source coupled to a microwave antenna that is placed in the antenna chamber of the microwave containment vessel, providing a microwave reflector beyond the interior surface of the material holding cavity, activating the microwave source to cause the antenna to emit microwaves to heat the material and align the molecular structure of the material in the material holding cavity, continuing to cause the material to be heated and aligned for a predetermined amount of time, cooling the material to from a solid with an aligned molecular structure wherein the alignment of the molecular structure is the alignment of the spins of the quarks in the nucleon of a plurality of atoms.
An object of this invention is a method of producing a molecularly aligned material comprising the acts of: providing a material holding vessel with a wall having an exterior surface and an interior surface defining a cavity, the material holding vessel shaped in the form of a coil and space within the interior of the coil for the insertion of an antenna along an axis of the coil, the material holding vessel being transparent to microwave energy, providing a microwave reflector outward of the portion of the exterior surface of the wall of the material holding vessel that is furthermost from the antenna, providing a microwave source coupled to a microwave antenna that is placed into the interior of the coil along an axis of the coil, providing a molten material to flow into the material holding vessel, flowing a molten material through the cavity of the material holding vessel, activating the microwave source to cause the antenna to emit microwaves to heat and align the molecular structure of the material in the material holding vessel.
An object of this invention is a method of producing a molecularly aligned material comprising the acts of: providing a material holding vessel comprising a plurality of tubes, the tubes having a wall with an exterior surface and an interior surface defining a cavity, the tubes radially positioned along an axis of a space for an antenna, the tubes transparent to microwave energy, providing a microwave reflector outward of the portion of the exterior surfaces of the tubes that are furthermost from the space for the antenna, providing a microwave source coupled to a microwave antenna that is placed in the space between the radially spaced tubes, providing a molten material to flow through the tubes, activating the microwave source to causer the antenna to emit microwaves to heat and align the molecular structure of the material in the tubes.
An object of this invention is a method of producing a molecularly aligned material comprising the acts of: providing a material holding vessel comprising a plurality of tubes, the tubes having a wall with an exterior surface and an interior surface defining a cavity, the tubes radially positioned along an axis of a space for an antenna, the tubes transparent to microwave energy, providing a microwave reflector outward of the portion of the exterior surfaces of the tubes that are furthermost from the space for the antenna, providing a microwave source coupled to a microwave antenna that is placed in the space between the radially spaced tubes, providing a molten material to flow through the tubes, activating the microwave source to causer the antenna to emit microwaves to heat and align the molecular structure of the material in the tubes, wherein providing a plurality of tubes includes providing a plurality of tubes joined together at the top of their structure.
An object of this invention is a method of producing a molecularly aligned material comprising the acts of: providing a material holding vessel comprising a plurality of tubes, the tubes having a wall with an exterior surface and an interior surface defining a cavity, the tubes radially positioned along an axis of a space for an antenna, the tubes transparent to microwave energy, providing a microwave reflector outward of the portion of the exterior surfaces of the tubes that are furthermost from the space for the antenna, providing a microwave source coupled to a microwave antenna that is placed in the space between the radially spaced tubes, providing a molten material to flow through the tubes, activating the microwave source to causer the antenna to emit microwaves to heat and align the molecular structure of the material in the tubes, wherein providing a plurality of tubes includes providing a plurality of tubes joined together at the bottom of their structure.
An object of this invention is a method of producing a molecularly aligned material comprising the acts of: providing a material holding vessel comprising a plurality of tubes, the tubes having a wall with an exterior surface and an interior surface defining a cavity, the tubes radially positioned along an axis of a space for an antenna, the tubes transparent to microwave energy, providing a microwave reflector outward of the portion of the exterior surfaces of the tubes that are furthermost from the space for the antenna, providing a microwave source coupled to a microwave antenna that is placed in the space between the radially spaced tubes, providing a molten material to flow through the tubes, activating the microwave source to causer the antenna to emit microwaves to heat and align the molecular structure of the material in the tubes, wherein providing a plurality of tubes includes providing a plurality of tubes joined together at the beginnings of the tubes.
An object of this invention is a method of producing a molecularly aligned material comprising the acts of: providing a material holding vessel comprising a plurality of tubes, the tubes having a wall with an exterior surface and an interior surface defining a cavity, the tubes radially positioned along an axis of a space for an antenna, the tubes transparent to microwave energy, providing a microwave reflector outward of the portion of the exterior surfaces of the tubes that are furthermost from the space for the antenna, providing a microwave source coupled to a microwave antenna that is placed in the space between the radially spaced tubes, providing a molten material to flow through the tubes, activating the microwave source to causer the antenna to emit microwaves to heat and align the molecular structure of the material in the tubes, wherein providing a plurality of tubes includes providing a plurality of tubes joined together at the endings of the tubes.
An object of this invention is an apparatus for the producing hydrogen and oxygen gases from water involving distillation, said apparatus comprising: a microwave containment vessel having: (i) a material holding vessel with a wall having an exterior surface and an interior surface, and a defining cavity; (ii) an antenna chamber, the antenna chamber formed of a microwave transparent material, and protruding into the material holding vessel, a microwave source, a microwave antenna connected to the microwave source, the microwave antenna positionable in the antenna chamber, the antenna chamber providing physical isolation between the microwave antenna and the material holding vessel of the microwave containment vessel, a microwave reflector beyond the interior surface of the wall, a port for the vapor to exit, a electrolysis field device located in the path of the said port for the exit of the vapor comprising of a negative and positive electrode, a power source for the positive and negative electrode, a path with a negative electrode to attract the hydrogen, a path with a positive electrode to attract the oxygen, a collection vessel for the hydrogen, a collection vessel for the oxygen.
An object of this invention is an apparatus for a higher heat output than equivalent electrical input comprising: a molecularly aligned palladium electrode, a platinum electrode, an electrical field between the molecularly aligned palladium electrode and platinum electrode, a power source for the electrical field, a solution of molecularly aligned heavy water for the placement into the molecularly aligned palladium and platinum electrode.
An object of this invention is a method of the producing hydrogen and oxygen gases from water involving distillation, comprising the acts of: providing a microwave containment vessel having: (i) a material holding vessel with a wall having an exterior surface and an interior surface, and a defining cavity; (ii) an antenna chamber, the antenna chamber formed of a microwave transparent material, and protruding into the material holding vessel, providing a microwave source, providing a microwave antenna connected to the microwave source, the microwave antenna positionable in the antenna chamber, the antenna chamber providing physical isolation between the microwave antenna and the material holding vessel of the microwave containment vessel, providing a microwave reflector beyond the interior surface of the wall, activating the microwave source to cause the antenna to emit microwaves to heat the material in the material holding cavity, providing a port for the vapor to exit, providing a electrolysis field device located in the path of the said port for the exit of the vapor comprising of a negative and positive electrode, providing a power source for the positive and negative electrode, activating the electrolysis field to cause the vapor to separate into hydrogen and oxygen, providing a path with a negative electrode to attract the hydrogen, providing a path with a positive electrode to attract the oxygen, providing a collection vessel for the hydrogen, providing a collection vessel for the oxygen, collecting hydrogen into its collection vessel and collecting oxygen into collection vessel.
An object of this invention is a method of having a higher heat output than equivalent electrical input comprising: providing a molecularly aligned palladium electrode, providing a platinum electrode, providing an electrical field between the molecularly aligned palladium electrode and platinum electrode, providing a power source for the electrical field, providing a solution of molecularly aligned heavy water for the placement into the molecularly aligned palladium and platinum electrode, activating the electrical field between electrodes to cause the heavy water to separate into D₂ and oxygen causing the D₂ to become entrapped into the palladium electrode with another D₂ and fuse into a helium atom and excess energy of formation.
An object of this invention is a method of having a higher heat output than equivalent electrical input comprising: providing a molecularly aligned palladium electrode, providing a platinum electrode, providing an electrical field between the molecularly aligned palladium electrode and platinum electrode, providing a power source for the electrical field, providing a solution of molecularly aligned heavy water for the placement into the molecularly aligned palladium and platinum electrode, activating the electrical field between electrodes to cause the heavy water to separate into D₂ and oxygen causing the D₂ to become entrapped into the palladium electrode with another D₂ and fuse into a helium atom and excess energy of formation, wherein the excess energy of formation is a neutron.
An object of this invention is a method of having a higher heat output than equivalent electrical input comprising: providing a molecularly aligned palladium electrode, providing a platinum electrode, providing an electrical field between the molecularly aligned palladium electrode and platinum electrode, providing a power source for the electrical field, providing a solution of molecularly aligned heavy water for the placement into the molecularly aligned palladium and platinum electrode, activating the electrical field between electrodes to cause the heavy water to separate into D₂ and oxygen causing the D₂ to become entrapped into the palladium electrode with another D₂ and fuse into a helium atom and excess energy of formation, wherein the excess energy of formation is in the form of heat.
An object of this invention is a method of producing molecularly aligned water by microwave energy comprising the acts of: providing a microwave containment vessel having a material holding cavity and an antenna chamber, the antenna chamber formed of a microwave transparent material, and extending through a surface of the microwave containment vessel and into the material holding cavity, and the antenna chamber opening is located along and centered on an axis of the material holding cavity, putting water into the material holding cavity, providing a microwave source coupled to a microwave antenna that is placed in the antenna chamber of the microwave containment vessel, providing a microwave reflector beyond the interior surface of the material holding cavity, activating the microwave source to cause the antenna to emit microwaves to heat the water in the material holding cavity, continuing to heat the water in the material holding cavity to generate steam, passing the steam through a condensation coil in communication with the containment vessel; and cooling the steam to form the distillate.
An object of this invention is a method of producing a molecular aligned material comprising the acts of: providing a microwave containment vessel having a material holding cavity and an antenna chamber, the antenna chamber formed of a microwave transparent material, and extending through a surface of the microwave containment vessel and into the material holding cavity, putting material into the holding cavity in the vapor state, providing a microwave source coupled to a microwave antenna that is placed in the antenna chamber of the microwave containment vessel, providing a microwave reflector beyond the interior surface of the material holding cavity, activating the microwave source to cause the antenna to emit microwaves to heat the material and align the molecular structure of the material in the material holding cavity, continuing to cause the material to be heated and aligned for a predetermined amount of time, cooling the material to from a solid with an aligned molecular structure.
An object of this invention is a method of producing a molecularly aligned material comprising the acts of: providing a material holding vessel with a wall having an exterior surface and an interior surface defining a cavity, the material holding vessel shaped in the form of a coil and space within the interior of the coil for the insertion of an antenna along an axis of the coil, the material holding vessel being transparent to microwave energy, providing a microwave reflector outward of the portion of the exterior surface of the wall of the material holding vessel that is furthermost from the antenna, providing a microwave source coupled to a microwave antenna that is placed into the interior of the coil along an axis of the coil, providing a vapor to flow into the material holding vessel, flowing a vapor through the cavity of the material holding vessel, activating the microwave source to cause the antenna to emit microwaves to heat and align the molecular structure of the vapor in the material holding vessel.
An object of this invention is a method of producing a molecularly aligned material comprising the acts of: providing a material holding vessel comprising a plurality of tubes, the tubes having a wall with an exterior surface and an interior surface defining a cavity, the tubes radially positioned along an axis of a space for an antenna, the tubes transparent to microwave energy, providing a microwave reflector outward of the portion of the exterior surfaces of the tubes that are furthermost from the space for the antenna, providing a microwave source coupled to a microwave antenna that is placed in the space between the radially spaced tubes, providing a vapor material to flow through the tubes, flowing a vapor through the plurality of tubes, activating the microwave source to cause the antenna to emit microwaves to heat and align the molecular structure of the vapor in the tubes.
An object of this invention is a method of producing a molecularly aligned material comprising the acts of: providing a material holding vessel comprising a plurality of tubes, the tubes having a wall with an exterior surface and an interior surface defining a cavity, the tubes radially positioned along an axis of a space for an antenna, the tubes transparent to microwave energy, providing a microwave reflector outward of the portion of the exterior surfaces of the tubes that are furthermost from the space for the antenna, providing a microwave source coupled to a microwave antenna that is placed in the space between the radially spaced tubes, providing a vapor material to flow through the tubes, flowing a vapor through the plurality of tubes, activating the microwave source to cause the antenna to emit microwaves to heat and align the molecular structure of the vapor in the tubes 21 wherein the product of the distillate is a source of material for another pass through the apparatus and variations described herein, one or more times.

The preferred embodiments of the invention presented here are described below in the specification and shown in the drawing figures. Unless specifically noted, it is intended that the words and phrases in the specification and the claims be given the ordinary and accustomed meaning to those of ordinary skill in the applicable arts. If any other special meaning is intended for any word or phrase, the specification will clearly state and define the special meaning. In particular, most words commonly have a generic meaning. If I intend to limit or otherwise narrow the generic meaning, I will use specific descriptive adjectives to do so. Absent the use of special adjectives, it is my intent that the terms in this specification and claims be given their broadest possible, generic meaning.

Likewise, the use of the words “function,” “means,” or “step” in the specification or claims is not intended to indicate a desire to invoke the special provisions 35U.S.C. 112, Paragraph 6, to define the invention. To the contrary, if the provisions of 35U.S.C. 112, Paragraph 6 are sought to be invoked to define the inventions, the claims will specifically state the phrases “means for” or “step for” and a function, without also reciting in such phrases any structure, material or act in support of the function, if they also recite any structure, material or acts in support of that means or step, then the intention is not to invoke the provisions of 35 U.S.C. 112, Paragraph 6. Moreover, even if the provisions of 35 U.S.C.112, Paragraph 6 are invoked to define the inventions, it is intended that the inventions not be limited only to specific structure, material or acts that are described in the preferred embodiments, but in addition include any and all structures, materials or acts that perform the claimed function, along with any and all known or later-developed equivalent structures, material or acts for performing the claimed function.

### DESCRIPTION OF THE DRAWING FIGURES

I have included 42 drawings:

FIG. 1 is a schematic drawing of the invention used in a water distillation system.

FIG. 2 is an illustration of the containment vessel with chamber I had made for this invention.

FIG. 3 is an illustration of a magnetron removed from a LG microwave oven.

FIG. 4 is an illustration of the containment vessel with chamber sitting on a microwave generator source (magnetron) and the antenna inserted into the cavity or chamber in the containment vessel.

FIG. 5 is an illustration of a working breadboard and model of this invention that I built and tested.

FIG. 6 is another illustration from a different viewpoint of a working breadboard and model of this invention that I built and tested.

FIG. 7 is an illustrative drawing of an electromagnetic wave with the direction of propagation, electric and magnetic fields shown;

FIG. 8 is an illustrative drawing of an electromagnetic wave looking down the axis of propagation, showing various directions of possible different orientations of the electric field vector for illustrative purposes;

FIG. 9 is an illustrative drawing of the resolution of an electric field vector into two components, along an x and y axis.

FIG. 10 is a top illustration of fluid holding vessel 106 showing rf (microwave) emittance pattern vectors 200 and electrical field vectors 202.

FIG. 11 illustrates a series of H₂O molecules and their alignment under an EMF field.

FIG. 12 illustrates a series of H₂O molecules and their alignment under an EMF field.

FIG. 13 illustrates the polar character of a water molecule with the bonding angle between hydrogens and the molecular bonding spins.

FIG. 14 illustrates a water molecule with changed molecular bonding spins between the hydrogen and oxygen atoms.

FIG. 15 illustrates a series of H₂O (water) molecules bonded in a matrix of water.

FIG. 16 illustrates the microwave antenna 108 and the axis used for illustration purposes.

FIG. 17 illustrates the radiation pattern of the microwave antenna 108 in the Z, Y planes.

FIG. 18 illustrates the radiation pattern of microwave antenna 108 in the X, Y planes.

FIG. 19 illustrates a vertically polarized rf (microwave) wave emitted from microwave antenna 108.

FIG. 20 illustrates a horizontally polarized rf (microwave) wave emitted from microwave antenna 108.

FIG. 21 illustrates fluid holding vessel 106 in an alternate embodiment along with the level of the water and a steam area above the water line.

FIG. 22 illustrates a matrix; water molecules.

FIG. 23 illustrates a neutron and the axis and spin orientation used for illustration purposes.

FIG. 24 illustrates an embodiment of the intermediate collection vessel for reprocessing the steam from fluid holding vessel 106.

FIG. 25 illustrates the coating layers of a reflector on a surface of a vessel.

FIG. 26 illustrates a reprocessing method for the distilled water.

FIG. 27 illustrates water cooling for the magnetron.

FIG. 28 illustrates preheating the incoming water with the cooling for the magnetron.

FIG. 29 illustrates an embodiment of the invention with tubes for the heating of material

FIG. 30 illustrates an embodiment of the invention with a spiral tube for the heating of material

FIG. 31 illustrates an embodiment of separation of hydrogen and oxygen.

FIG. 32 illustrates the proton/electron/quack interaction for S¹

FIG. 33 illustrates the proton/electron/quack interaction for S²

FIG. 34 illustrates an embodiment of the invention for the generation of hydrogen and oxygen

FIG. 35 illustrates an illustration of a process of electrolysis

FIG. 36 illustrates the state of electrons in a metal

FIG. 37 illustrates the state of electrons in a metal after the metal is processed from this invention

FIG. 38 illustrates the effects upon heavy water

FIG. 39 illustrates an electron traveling through metal

FIG. 40 illustrates an electron traveling through metal

FIG. 41 illustrates a material cylinder manufactured by a process of this invention

FIG. 42 illustrates a material cylinder being peeled that is manufactured by a process of this invention

### SUMMARY

The principle of microwave generators, sources and amplifiers are well understood and documented. As also is the principle of heating substances with microwaves as evidenced by the current popularity of the microwave oven in modem society. Briefly, microwaves in microwave ovens cause the water in the inserted matter to vibrate at a resonant frequency (that is, their bonds) and cause the molecules to become “excited”. As a simplified explanation this causes the water molecules to “bump” into each other and cause heating because of the collisions of the water molecules. This is why the substance being cooked or heated in a microwave oven will become hot from the inside out and continue to heat even after the microwave energy source has been turned off. Microwave ovens are typically a square enclosure made of metal that reflect microwaves back into the formed cavity with a microwave generator coupled to the enclosure through a wave-guide that directs the microwaves into the oven. The distribution of microwaves into the cooking area, or cavity is dispersed and non coherent. The emitted microwaves are emitted into the cavity in an uncollimated incoherent pattern trying to get as wide of dispersal as possible. This arrangement can cause hot spots in the heating of substances in the cooking cavity at the nodes of the microwave frequency lengths, so the microwaves are either “stirred” or the substance is rotated to intersect at different spots in the substance where the nodes occur. The hot spots are also caused by the geometry of the material to be heated being at different distances from the microwave source and the microwave distribution pattern from the source and the wave-guide. Furthermore, the typical microwave generator can become very hot, so a fan is used to cool the generator (of which one typical generator is called a Magnetron manufactured by LG model number 2M213-24OGPo). There are many manufactures of magnetrons and microwave generators. These microwave generator devices are usually set for only one frequency, somewhere between 2.4 and 2.6 GHZ. It has been determined by others that this is the best frequency to cook foods, however other frequencies are understood to be better for other materials and substances depending upon the materials and needs and requirements. For instance, the article at URL—http://www.straightdope.com/mailbag/mmicrowave2.html, by A Staff Report by the Straight Dope Science Advisory Board, herein incorporated by reference, points out that 10 GHz is better for heating water molecules alone not bound in another substance. For the sake of this patent it is understood that when a frequency is mentioned for a microwave generator that it can use frequencies other than the one mentioned depending upon the application and the material used. Also, that the material heated can be a fluid, a solid, a vapor, or plasma depending upon the application and desired results.

All matter, as we currently understand it today in regards to physics and science, consists of a conglomeration (a number of different things or parts that are put or grouped together to form a whole but remain distinct entities) of particles to make up an atom of substance. These particles are described as the nucleus of the atom consisting of protons (with a positive charge) and/or neutrons and surrounding particles called electrons (with a negative charge) which “orbit” the nucleus of the atom much like the earth orbits around the sun. However, these particles can also be described as wave functions which are really spatial functions describing their “sphere” or volume of influence on other particles. The “volume of influence” implies that the component associated with the wave function or particle, describing the volume of influence, has a time component, spatial component, a velocity component, direction component, spin component, mass component, momentum component, etc.

Albert Einstein postulated the formula of E=mc², which relates energy to mass by a constant c. This formula states that energy can be converted to mass, and mass to energy. It also means that the two are indistinguishable from one another. The common physics definition of energy is that it describes the ability to do work. Thus we can restate Einstein's equation as the ability to do work equals the mass of the studied system and the speed of that system. However, it is far more extensive than that.

There is a physics postulate that states energy can neither be made nor destroyed. What this states is that the total system energy is preserved. This does not mean that all energy must stay in the same state, but can change from one form to another, or several different others, but the total energy must equal the original. By combining this with Einstein's equation, we can see that the energy of a particular individual system can change from one state of energy to another (lower) state of energy plus a particle of mass with properties that are equal to the difference between the original energy system and the new energy system “generated.” This is written as
E⁰=E¹+mc²
Where E⁰ is the original energy of the system, E¹ is the new energy in the system (released energy, new mc², etc) and mc² is the new mass in the system. Note however, E⁰ stays the same, that is, the total energy of the system

The energy formula can also be stated as:
E_{T}=E₁+E₂+E₃. . . . E∝
Where E_{T} is the total energy of the system, E, is the energy of the first system, E₂ is the energy of the second system, E₃ is the energy of the third system, Eₙ¹ is the energy of the nth particle.

Since E₁ can be written as either a wave function or understood as a particle function, mc², it can be seen that a new system (state) is “created” by the formula, thus two particles can be created, or a particle and a wave function, or several particles and wave functions, but all “created” systems must still total together the energy of the original system.

It has been postulated in physics that the study of gravity and the study of particle physics, or quantum physics, are two different areas of study, not one single equation or understanding that unifies them. The quest for the understanding of gravity with all of the other forces that we understand is called the Unified Theory.

All “energy systems” try to be in the lowest possible state of energy possible, or restated in another way, in a state where the least amount of “work” to sustain a system is expended. This involves “creating” multiple systems with lower energies than the original system, but the sum of all new systems must equal the original system. This governs all particles in the entire universe.
E₀=E₁+E₂+E₃. . . . E∝
This formula states that lower energy systems can be generated from higher energy system, but also shows that higher energy level systems can be created from lower energy systems. By “forcing” two or more systems together (E₁+E₂) under an external influence, which might consist of using another energy system (E₃) to help create the reaction, a new Energy system is created with higher energy, but all of the energy “used” in the creation of the new system (E₁+E₂+E₃) is equal to the energy of the new system. This is the conservation of energy.

Matter decays, over time, to lower states of energy, and is usually stated as the half-life of the material. In the process of the new material appearing, the old system creates multiple systems of energy each being in a lower state than the original. The lowest state of energy, is the greatest number of individual atoms with the least amount of neutrons/protons and electrons in a stable configuration.

It is this lowering of the average energy of all the energy states that unifies the gravity and other force fields into one. This lowering of the average energy of the individual systems is caused by the atoms interacting with one another, and for this to happen they must be as close in space as possible. This affinity for one another is based upon the number of particles in an individual system (thus the higher E). An energy system with a greater number of particles in the nucleus, thus mass, will have more affinity towards other particle systems with less mass. That is because the particle system with more mass has more cause to lower its overall average individual particle energy than the one with less mass.

The way an energy system lowers its average individual energy is through interaction when individual energy systems are within the “sphere of influence” of one another. For particle systems, the energy is lowered through interaction of forces that cause the highest mass system to lose some of its mass or to reconfigure its mass system to a lower sustainable energy system that is more stable.

The forces between the particles in an atom (intra-atomic) system consist of the interaction between the particles in the nucleus, the interaction of the nucleus and electron “cloud” of orbiting electrons, the electrons to electrons interaction. These forces are described as being 1) the strong force, 2) the electromagnetic force, and 3) the weak force.

The strong force is a force which holds the nucleus particles together in close proximity to one another against the forces of repulsion between one another. It has a very short range. The electromagnetic force manifests itself as either a repulsion or attraction due to charges on the individual particles. Like charges repel (the particles) while dissimilar charges attract (or the particles are drawn toward each other.) It is force that acts at infinite range but obeys the inverse square law for the amplitude of its value for attraction or repulsion. The weak force interaction concerns the reaction between the particles in a nucleus. It causes protons to turn into neutrons and is concerned with transmutations of quarks, which are some of the particles that constitute protons and neutrons, and allow a proton turn into a neutron or visa versa.

Since the elemental “object” of the universe is to have the lowest average energy of individual systems while maintaining the overall total energy, then each individual energy system tries to have the lowest average stable energy. For this law to be observed, each of the particles must interact with the other particles making up the system of the atom to be as stable as possible. If some of the particles are “unstable”, not in the lowest stable energy state possible, then they move towards stability by interaction among intra-molecular forces and intermolecular forces. Thus the elements in the periodic table that are most reactive are not yet in a lowest possible average energy state while the highly inactive elements (in the far column of the periodic table, column 18) are in the lowest average energy state for their particular row, until such time an interaction with another substance will lower them to yet even another lower state. An induced interaction can cause them to gain particles or change the state of the particles they have to a higher energy level that is capable of interacting or change.

The atoms that have the most stable configurations are those having all of their valence electron spots filled and all intra-molecular forces are balanced, or counter balanced, so that the internal forces can cancel out the possible influence of external forces. These elements, noted as nobel gases, are extremely stable at normal earth temperatures, and do not form other bonds readily. They do not form bonds among themselves readily.

All of the particles in an atomic system interact with the individual forces of all of the other particles to arrive at an energy level. If the spins, rotations, repulsions, speeds, directions, etc. of the individual particles are so balanced that it (the atom) is in the lowest energy level, then this atom is stable and is an inactive element, i.e., it does not readily interact with other elemental atoms, although the individual particles will change their energy under the influence of the proper force or energy field, this causing the entire system to be unbalanced and interact with other atoms. However, the energy required to have a particle change its energy level is greater than an atom that does not have all of its particles balanced in the lowest energy levels.

When two or more atoms come together, they form chemical bonds—From the interaction of the electron charge clouds and the electron density in the outermost shells, or the valence electrons.

As defined by “The Cassell Dictionary of Science”, by Percy Harrison and William Waites, 1999, herein incorporated by reference, a chemical bond is: “The force of attraction that holds atoms together in a molecule or lattice. Chemical bonds are of sufficient force that they can only be broken by a chemical reaction and not by thermal vibrations at the temperatures under consideration.” This statement also implies that chemical bonds can be broken by increasing thermal vibrations by increasing thermal temperatures. Furthermore, vibrations can be increased by “dumping” energy into the bonds, which increases the “thermal” activity or properties of the bond.

Bonds can be ionic and covalent. Ionic, or electrovalent bonds arise from the electrostatic forces of attraction between oppositely charged ions. In covalent bonding, pairs of atoms share electrons to form a bond that is directed in space.

Polar bonds: the bond is regarded as covalent but the electron pair in the bond spends more time with one atom than the other. This polarizes the molecule so it has a negative charge on one end, which acts as an ionic bond.

Physics classify “states of matter”, and refer to these states as phases, with the solid state, liquid state and gaseous state. The solid state is characterized as having the particles (either individual atoms or molecules) in a symmetrical array or lattice whereby the particles are not free to move from their geometrical position in space. These type of material are formed under the influence of ionic and covalent bonding and van der Waals forces whereby the forces are strong enough to “hold” the particles in place at their given energy levels (temperatures). Molecules are collections of atoms bound together, and the atoms can all be identical or of different elements.

When the bonding forces are not of sufficient strength to hold the particles in place (geometrically in space) but will allow them to break and form new bonds on a regular basis, such that the particles “flow”, then the particles are said to be in a liquid state. The amount of flow is dependent upon the time factor of breaking and forming new bonds with other particles and the strength of these particles.

The next state, the gaseous phase, occurs because the individual particles (atoms, molecules) have sufficient energy to not be influenced by the energy forces of the surrounding particles to bond. As the energy of individual particles increase, the bonding tendency decreases, until such time that the tendency to form another substance (particles or molecules) is nonexistent.

Heat flows from hot to cold. The particles try to lower their average energy state, if possible, by forming other poly-particles with an average lower energy state. All particles try to lower their average energy state, of which they can do this by forming unions with other particles, if there is not an external influence that raises their energy.

We express heat as either hot, warm, or cold and rate it on a temperature scale. However, heat is really the “energy” of the atoms and their vibrations, with the higher activity of the vibrations being related to “hot”. This is a relative scale, and is really based upon the human experience of feeling in our nerves being able to generate an experience. Any atoms that vibrate at a rate or amplitude that interact with our bodies and cause a sensation can be rated on a temperature scale. It really denotes the capability to do damage by the transfer of energy to our human bodies and disrupt their normal functions. We have also devised ways of using other materials to interact with what is being measured. We then measure the interaction to give it a rating of the transfer of energy between the two systems and relate this to a temperature scale of choice.

These vibrations of the atoms are the motions of the individual particles relative to one another. At absolute zero the individual particles do not move relative to one another. This includes the protons in the nucleus relative to one another and the nucleus relative to the corresponding electrons of the atom and the electrons relative to one another. As temperature increases, so does the motion relative to one another, etc. This causes an oscillation between the particles and in the particles as the interactions start becoming more energetic. These inter-atomic reactions tend to be harmonic and since they are harmonic they also have resonant modes.

Therefore if an outside source of energy frequency is coupled into the frequency of inter-atomic reactions (“bond”) between particles, this bond can have its frequency increased, can have its amplitude increased, or both, which causes the energy of the atomic system to be raised. This also applies to the molecular system of bonding also. Since the interaction between particles is dependent upon this bond (“harmonic vibration of movement or interaction”), the bond between particles can become “broken” by too large of amplitude, shift in frequency, or both.

The following describes what happens when sufficient energy is pumped into a bond between a particle and the particles bonded to it to break the bond. The force that is holding it (the particle) in place (being attracted to its individual atom or molecule) can have its oscillations so increased by the new energy in the bond that the spatial excursions (or momentum, spin, etc.) become so large that the forces that hold the particles in the system actually cause the particles to become unbound. However, because this new particle now has higher energy (because it is in an “unstable” condition) it is then free to react, with other particles, thereby transferring it energy to another system that is capable of accepting it.

When a high energy particle encounters a lower energy particle, the higher energy particle will “deliver”, or transfer, some of its energy to the other particle, until they have energies that correlate according to their individual masses. They will reach an equilibrium state between the two whereby the transfer of energy from one particle to the other is equal to the opposite transfer, thus reaching equilibrium, and the lowest state of average energy possible.

The movement of an electron causes a magnetic field, and the movement of a magnetic field causes an electric field (or movement of electrons). Another postulate of physics is that an object at rest will stay at rest until an outside force causes it to change. This also means that an object that is in equilibrium with its surroundings will stay in equilibrium until an outside force causes the system to change. The same can be stated about electromagnetic force, that is, it is the manifestation of causing a particle to change, it is the response to having caused an outside force to change the direction, spin, speed, momentum, etc. of the particle. Electrons have been called the guard of the nucleus by means of the electron field. The electron field in a stable atom cancels out the field of the nucleus, and the two are in equilibrium with one another. When a nucleus loses one or more of its electrons then it has a positive field and tries to gain electrons back so it becomes stable again. When it has picked up extra electrons it has a tendency to want to lose these extra electrons readily.

Because an atomic particle is an energy system, and that energy system consists of masses along with electromagnetic forces and other forces, the atom can be characterized by conventional mechanical theory along with the more modem quantum theory. It behaves like a particle (mass) and like a wave function. Because the individual parts of an atom make up its mass, the individual particles also have properties of a mechanical object. These include size (volume), mass, momentum, spin, direction, speed, rotation, etc.

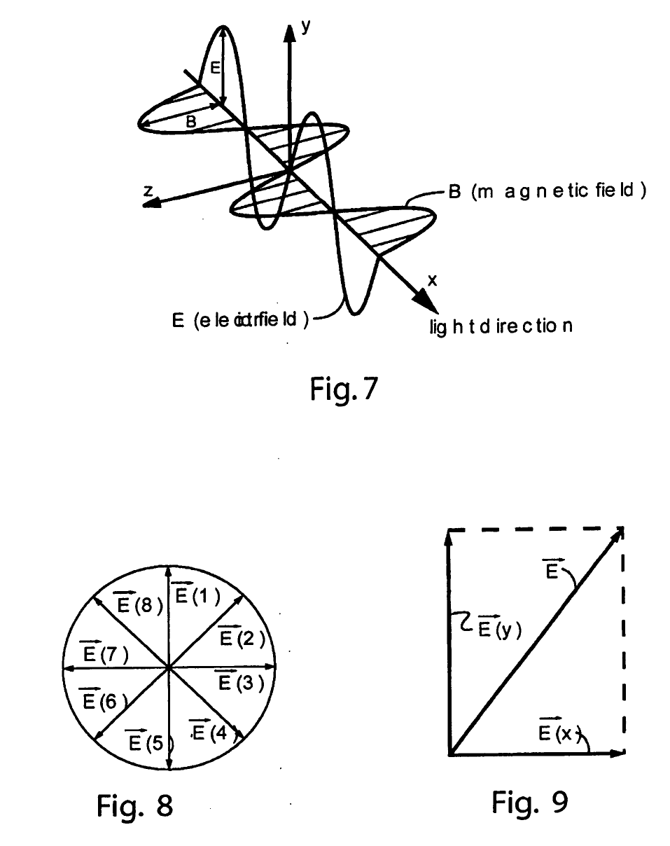

A disturbance (change in position or state of individual particles) in the fabric of space-time causes a sphere of influence. Stated in a simplistic manner, the action of one particle influences the actions of others near it. This sphere of influence is referred to as a “field”, and this field is designated as either electric or magnetic (after the way it influences other particles). The direction of travel of the particle is called the direction of propagation. The propagation of the particle, the sphere of influence, and the way it influences other particles is called an electromagnetic wave, and is shown in FIG. 7.

As shown in FIG. 7, the electric and magnetic fields are orthogonal (at right angles) to each other and the direction of propagation. These fields can be mathematically expressed as a vector quantity (indicating the direction of influence along with strength, i.e., magnitude, of influence) at a specific point or in a given region in space. Thus, FIG. 8 is the electromagnetic wave in FIG. 7, but with the view of looking down the axis of propagation, that is, down the x axis of FIG. 7. FIG. 7 shows some possible various electric field vectors that could exist, although it should be understood that any and all possible vectors can exist around the circle, each having different magnitudes.

Vectors can be resolved into constituent components along two axes. This is done for convenience sake and for generating a frame of reference that we, as humans, can understand. By referring to FIG. 9, it is shown that the electric field vector E, can be resolved into two constituent components, E(y) and E(x). These quantities, then, describe the orientation and the magnitude of the electric field vector along tow axes, the x and y, although other axes or systems could be chosen. The same applies to magnetic fields, except that the x and z axes would be involved.

The way the electronic and magnetic fields vary with time in intensity and direction of propagation have been determined by several notable mathematicians and physicists, culminating in a group of basic equations by James Maxwell. The equations, simply applied, state that a field vector can be of one of several different states, that is: 1) the field vector varies randomly over a period of time, or 2) the field vector can change directions in a circular manner, or 3) the field vector can change directions in a elliptical manner, or 4) the field vector can remain constant in magnitude and direction, hence, the field vector lies in one plane, and is referred to as planar the orientation of a field vector and the way it changes with time is called the state of polarization.

An electromagnetic wave can be characterized by its frequency or wavelength. The electromagnetic spectrum (range) extends from zero, the short wavelength limit, to infinity, the long wavelength limit. Different wavelength areas have been given names over the years, such as cosmic rays, alpha rays, beta rays, gamma rays, X-rays, ultraviolet, visible light, infrared, microwaves, TV and FM radio, short wave, AM, maritime communications, etc. All of these are just short hand expressions of stating a certain range of frequencies for electromagnetic waves.

Different areas of the EMF spectrum and masses and particles interact with electromagnetic influences upon them in various proportions, with the low end being more influenced by magnetic fields, and the high end being influenced by electric fields. Thus to contain a nuclear reaction, a magnetic field is used, while controlling light an electric field is used.

It has been surmised that most particles were created during the “big bang” over 15 billion years ago. However, certain particles and observation of the galaxies also point to some mass having an age of 23 billion years. It could be possible that several big bangs have occurred over the ages at different locations and that their masses have intermingled.

During this big bang the temperature is purported to rise to an incredible unimaginable temperature where no matter existed, but shortly afterwards (milliseconds) after the wave began to expand and the temperature dropped, matter started to form, and eventually filled the universe. Since that time matter has been decaying into less energetic particles on the average, with more particles being created with less average energy. The forming of particles follow strict physical rules, however, the individual particles that form atoms have become more and more individually randomly oriented because of lack of an outside influence to “align” them in respect to a source. For instance, the spin of a proton or electron can be influenced by a strong electromagnetic field that will orient the masses and the fields, and therefore the spins or rotations, in a direction of the field. For this to happen, the external field must be of substantial enough strength to affect the masses and fields of a particle system in regards to the other fields that are acting upon it. The neutron or electron can be affected by an electric field, a magnetic field, both, or by a photon. A RF field is such a field that will affect the mass and fields of a particle, as are other fields with different frequencies of oscillation. An RF field is a subset of the electromagnetic field (EMF) and is in the portion of the spectrum where radio waves are generated. Fields of sufficient strength and frequencies can affect the bonds of the particles as well as the masses themselves, and have the capability of coupling and transferring energy to the bonding fields. “The weak and electromagnetic forces appear to be so different from one another only because we happen to live at a late stage in the evolution of the universe, where it has become cold, crystalline and asymmetric. Long, long ago when our universe was hot and burning bright and unfit for mortal man, its symmetry was exquisite.” [Interactions-A Journey Through the Mind of a Particle Physicist and the Matter of This World, by Sheldon L. Glasgow with Ben Bova, 1988, pg. 206, herein incorporated by reference.] “Sakharov's third postulate is more speculative. It requires that all matter is radioactive, although only very slightly. It turned out in 1973, that the instability of matter is a necessary consequence of any attempt to forge the strong and weak forces into a truly unified theory. Thus, grand unification realized Sakharov's dream of a natural origin to the matter asymmetry of the universe.

There was a time, long, long, long ago, when the visible universe was very hot and so small that it would fit on a pinhead. The intense heat generated enormous numbers of particles and antiparticles of all species. Matter and antimatter were then on exactly the same footing. There was a great deal of matter in the universe, and there was an exactly equal amount of antimatter. For every quark there was an antiquark. Then the Sakharov mechanism came into play to generate a tiny asymmetry between the matter and antimatter. Among every billion particles were one or two excess quarks. As the universe cooled, every antiquark found a quark to annihilate with, leaving only a few remaining quarks. The survivors combined in threes to form nucleons, the stuff of which our universe is mostly made. [Interactions-A Journey Through the Mind of a Particle Physicist and the Matter of This World, by Sheldon L. Glashow and Ben Bova, 1988, pg. 266-267,herein incorporated by reference.]

If an RF field that is either collimated and co-linear or originates from a single polarized source is applied to an atom or group of atoms (molecules) and the energy of the individual atoms are in such a state so that the particles of the individual atoms can be influenced (rotated, aligned according to direction, spin, polarization, etc.) then the individual particles can have their bonding properties changed, hence the material physical characteristics, while still maintaining the combinational structure of the original atom. The RF field can also be replaced by a different type of EMF field as long as it has an effect upon the particles in the field. It might be of different frequency that affects the bonds or electromagnetic alignment of the particles by spin alignment, rotation alignment, direction alignment, etc. This means the individual particles or molecules should not be “locked” into their quantum state or bonded so tightly that they cannot influence the bonding properties that are affected by the induced field.

As stated before, alignment of the molecules spins of the individual bonds and particles can occur by an external EMF field. If the EMF field has a constant propagation (direction) vector and a constant electric direction or magnetic direction vector then the alignment will occur in a constant direction. In water this can occur by first separating the bonds of each water molecule from the surrounding water molecules by raising the temperature of the mass of the water until it becomes steam. Each water molecule is then free from the bonding influence exerted by the other molecules. The internal bonds of the individual water particles are of an energy state that a strong electromagnetic field (EMF) of the correct frequency (microwave) and constant propagation vector can interact with the individual particles of the atoms constructing the water molecule and cause the bonds rotation vectors, the masses, or both to rotate in the same direction with the other particles of the atoms. This must be done in a coherent field or in a field that originates at a single polarized source with all of the water molecules surrounding it and a constant direction vector with a constant electric direction or magnetic direction field vector, that is, a polarized field. The magnitude of the amplitude of the fields (magnetic and electric) can and does vary as a sinusoidal function.

This also is achieved with other materials as long as the correct field is applied and the individual particles of the atoms are free to have their field or bond properties changed. For instance, a solid metal could be caused to become a liquid, a field is applied, the particles aligned by the external field, then cooled down again to the solid phase. Such a metal would have very little resistance to an electron moving through the metal structure because the interaction between the electron (with the correct spin or rotation) would be at a minimal state. This is how a metal would become a super conductor at room temperature. However, it could also be made for high resistance due to opposite spins.

Other materials can also be processed this way, or even turned into gasses and have a field applied. It would then create entirely new physical properties for the same chemical composition of materials. Because transistors and microchips utilize electron flow through materials, it is important to have very pure materials. Even with pure materials, electrons meet resistance to their passage through the material. As they move through, this resistance shows up as heat and reduced electron flow. By making the material with most of the material having their rotations and spins in a coherent direction, the interaction between the electrons and the fields of the individual particles can be minimized, thereby reducing heat and effecting less resistance to passage of electrons through a material.

### DESCRIPTION OF THE INVENTION

Water is the triatomic molecule composed of hydrogen and oxygen. It has two hydrogen atoms bonded to an oxygen atom as the basic molecule. The molecular weight of water is 18. The density of water, at standard temperature and pressure is, by definition 1 gram per centimeter cubed. The density of molecules in liquid water is approximately 3×22 per centimeter cubed. The spacing between the hydrogen and oxygen atoms is approximately 1 angstrom. The hydrogen atoms have a molecular weight of 1 each (consisting of a single proton and no neutrons, with 1 electron), and the oxygen has a molecular weight of 16 (consisting of 8 protons, 8 neutrons, and 8 electrons).

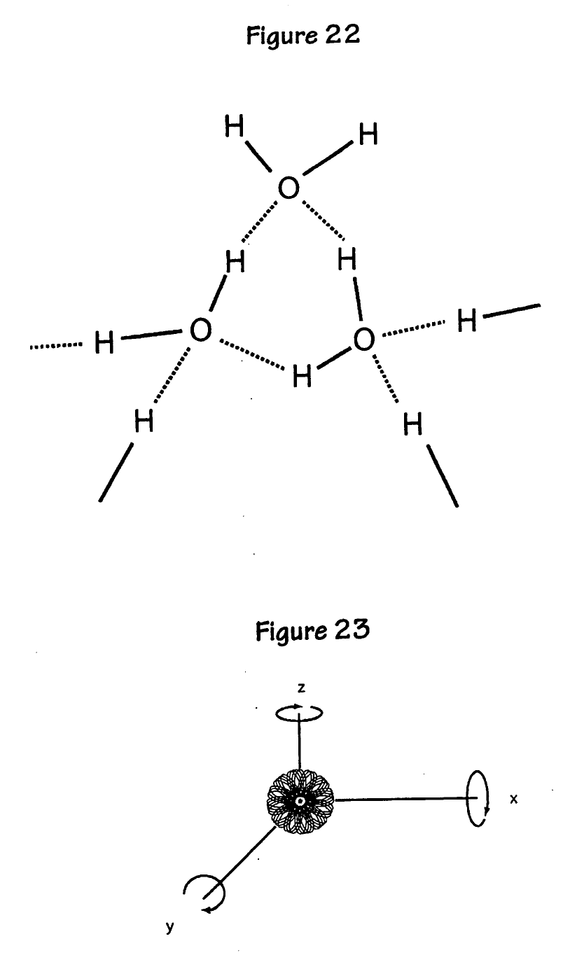

The bonding in water between molecules is referred to as hydrogen bonding. This bond is referred as this because the hydrogen(s) that are tightly bonded to one oxygen atom are also shared with other oxygen atoms to form water molecules. As can be seen in FIG. 15 and FIG. 22 the oxygen atom (each and every) has two primary hydrogen bonds (shown by dark lines) and two secondary hydrogen bonds (shown by dashed lines). This is for pure water. In “contaminated water”, or water that does not consist “purely” of hydrogen or oxygen atoms, the hydrogen atoms can be replaced by other atoms of different elements.

The capability of water to dissolve other elements and materials depends upon the fact that it can break the secondary bonds easily and readily (that is why water “flows”) and reform them again. Furthermore, if the energy levels are correct, it can also replace the primary hydrogens with different elements, trading a hydrogen and energy level for another atom to form a lower energy state, and molecule. That is, a molecule that is more stable, i.e., one less willing to exchange an atom for another without an impetus to do so, such as lowering its energy state again, or gaining energy to do so.

The nucleus of a hydrogen atom consists of a single proton. This proton further consists of particles that are bound together, by the strong nuclear force, which in turn might be a manifestation of the gravitational force. The proton is considered to have three particles that constitute the proton. These three particles are called fermions, which are of the class hadrons. All of these fermions have spin. A particle can have three axis of spin, x, y, z axis about its center of gravity. That is, it is capable of rotating about its center in three different directions. See FIG. 23. Rotation in the clockwise position looking down the axis toward the center point is positive rotation, while rotation counter-clockwise is negative rotation.

For a description of nuclear particles see John Gribbin, “Q is for Quantum An Encyclopedia of Particle Physics,” 1998, The Free Press, New York City, incorporated herein by reference.

baryon—The name for any fermion that feels the influence of the strong interaction (see forces of nature). All baryons are therefore members of the hadron family. The most important baryons are the proton and neutron, which make up most of the mass of ordinary atoms. For this reason, everyday matter is often referred to as ‘baryonic matter’. (pg. 36)

fermion—A particle which obeys Fermi-Dirac statistics. All fermions have half-integer spin (½, 3/2 and so on). They are the particles that make up what we usually think of as the material world (for example, the electron and the proton). Fermions are conserved-the total number of each kind of fermion stays the same, provided that in any interaction an antiparticle is counted as ‘minus one’ particles. (pg. 133)

hadron—Any particle that feels the strong force. All hadrons are composed of quarks. Baryons, which are particles in the everyday meaning of the term, are each composed of three quarks; mesons, which are force carriers, are each composed of a quark-antiquark pair. Baryons and mesons are both members of the hadron family. (pg. 170)

quark—General name for one kind of elementary particle, the fundamental building blocks from which all hadrons are constructed. Quarks feel the colour force (see quantum chromodynamics) and form a level of matter below that of neutrons and protons. All quarks have spin ½; some have ⅔ units of electric charge, and some have −⅓ units of electric charge (where the electron has −1 units). They come in six varieties offlavour (up, down, strange, charm, bottom and top) and three varieties of colour charge (red, green and blue). (pg. 325)

spin—A property of quantum entities which is related to the concept of rotation in classicalphysics-like the spin of the Earth in space-but which, as is usually the case in the quantum world, has no exact counterpart in the classical world.

Like other properties of quantum entities, spin is quantized and always comes in multiples of basic unit of spin, which is equal to half of (Planck's constant divided by 2π) or ½h. For convenience, the h bit is usually taken as read, and physicists refer to a particle as having spin ½, spin 1, spin 3/2, and so on. It turns out that the kind of spin a particle has is crucially important in determining its place in the quantum world. Particles which have an odd number of multiples of the basic unit of spin (and therefore have ‘half-integer’ spin overall) are fermions-particles, such as electrons and protons, that are what we think of as material particles. Particles which have zero spin or an even number of multiples of the basic unit of spin (and therefore have ‘integer’ spin overall) are bosons-particles, such as photons and gluons, that are what we think of as force carriers.

One of the strangest features of quantum spin is shown by the behavior of fermions, also known as ‘spin ½ particles’. If an object like the Earth turns in space through 360 degrees, it returns to where it started. But if a spin ½ particle rotates through 360 degrees, it arrives at a quantum state which is measurably different from its starting state. In order to get back to where it started, it has to rotate through another 360 degrees, making 720 degrees, a double rotation, in all. One way of picturing this is that the quantum particle ‘sees’ the Universe differently from how we see it. What we see if we turn through 360 degrees twice are two identical copies of the Universe, but the quantum particle is able to discern a difference between the two copies of the Universe.

The orientation of a spinning quantum particle such as an electron is also quantized, and this is why an electron can exist in either of precisely two states (with spin up or with spin down) for each energy level available to it in an atom. (pg. 371-372) (Mention why spin is up or down)

“The properties and interactions of the particle zoo fell into patterns that could be explained by their being made up of just three species of quark, called up, down and strange”.

Spin is crucial in determining how a particle behaves. For example, if electrons had any spin other than ½, the way that they stack into orbitals around an atom would be radically altered. The periodic table of elements and all of chemistry would be mutated beyond recognition.” [The Mystery of Nucleon Spin, by Klaus Rith and Andreas Schäfer, Scientific American, July 1999, incorporated herein by reference.]

The nucleus tries to stay in the most stable configuration possible, with three possible axis of rotation. The most stable configuration has been postulated to be three particles. They (the particles in a proton) must cancel one another out with regards to their spin so that the momentum of the total macro mass (the proton) is stable. The total system of three particles behaves like a pyramid with the center of gravity (mass) in the middle. However, as stated, a mass moving (or rotating) in space will generate a field that can influence other particles and this relates to the positive electric charge on the total entity, the proton.

The way the three particles spin and influence each other gives rise to the total macro spin of the combined masses. The most stable state of the proton is when the total macro spin of the particles comprising the proton are in their lowest state counter balancing one another. When enough energy is introduced into the proton to separate one particle from another it quickly becomes unstable. The proton begins “searching” for another particle to complete the triad. Such a release of a particle from the triad also frees the energy of the bonding between the two remaining particles and the free particle and in itself generates an enormous amount of energy. If there is a neutron close enough (neutrons consist of two quarks) then the remaining third particle can join in a reaction with the binary pair of quarks to form a triad, and thus stability and the total overall lowering of the system energy. The proton has become a neutron and the neutron a proton.

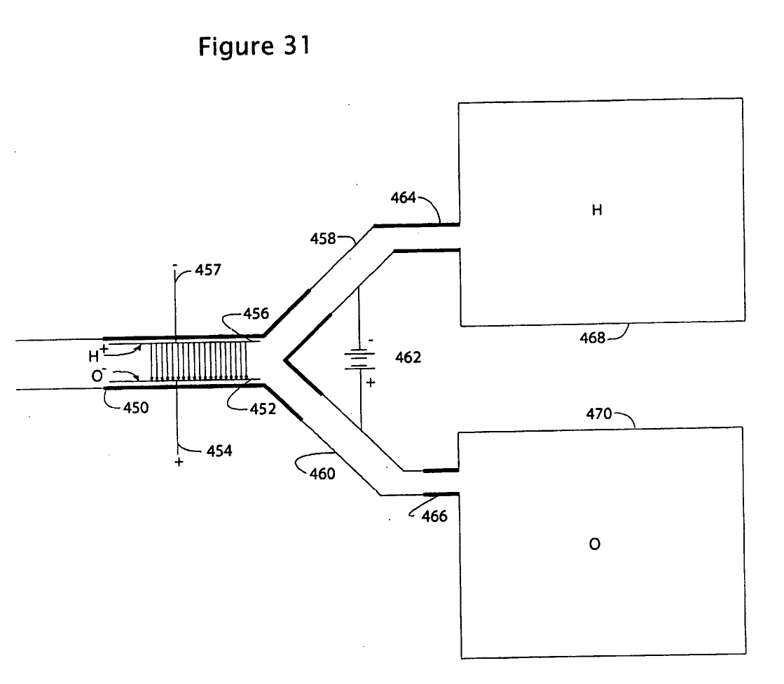

The three particles rotating together, about a common center of gravity will act as a common macro mass (see FIG. 31). That common macro mass acts as a single mass with its own spin vector according to what is currently measurable. It needs to be understood that these masses are so small and the ability to measure or see them is very limited at this time with the tools of science that are currently available. The proton is referenced as a macro mass consisting of other particles that is limited in ability to measure or see, and the particles themselves, or the particles that make up the particles are, or can be, very epherral in character. Sufficiently influencing the way the individual quarks spin, to influence the total macro proton spin. Conversely, by affecting the total proton spin it is possible to affect how the individual quarks interact with one another.

This combination of particles that produces the mass spin of the proton effects the spin and bond-spin of the electron(s) that surround the inner core (nucleus), where the electrons counter balance the charge on the nucleus and the spin of the nucleus by having their own spin and the energy of the bond-spin. It is a premise in physics that every action has a reaction. Thus, affecting the spin of the electron, the bond-spin between the nucleus will be affected, and thus eventually the spin of the nucleus could be changed. Also the spin of the nucleus can be changed, thus affecting the electron and bond-spin thereafter.

“In some respects, spin is more important in QCD than in atomic physics. A hydrogen atom, for example, can have a total spin of zero or one, depending on whether the proton and the electron orbiting it have their spins parallel or antiparallel to each other. But the difference in energy of these two alternatives is tiny. In contrast, consider the particle calledΔ⁺(delta plus, the sign indicating its electric charge of+1). It is made of the same three quarks as a proton, but the spins add up to 3/2 instead of ½. The Δ⁺is 30 percent more massive than a proton, meaning that aligned spins require more energy.” [The Mystery of Nucleon Spin, by Klaus Rith and Andrea Schäfer, Scientific American, July 1999, incorporated herein by reference.]

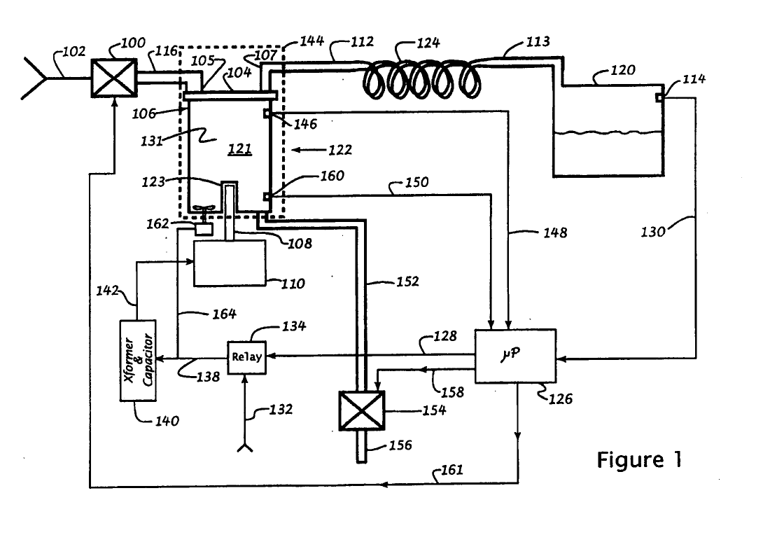

Referring to FIG. 1, the water, fluid, or material to be heated is connected via pipe 102 to a solenoid switch 100. This description will start with the invention in a startup state and then describe a complete cycle. While this demonstrates a batch processing technique and method, it should be understood that it could also be adapted to a continuous process. Microprocessor 126, which also can be a solid state controller, state sequencer, PROM, or other signal processor/determiner, processes the signal from level sensor 114 in collection holding vessel 120 and level sensor 146 in microwave containment vessel generally 122 and determines that water should be made. (In this example water will be used, but should be considered a subset of fluids and materials that can be processed this way.) In an embodiment of the invention the apparatus comprises a signal processor/determiner 126 having at least one signal input 150 and a first level sensor 160 in communication with the signal processor/determiner 126 through a first 150 of the at least one signal inputs.,The level of material in the fluid holding vessel or material holding cavity 106 of the microwave containment vessel, generally 122, is sensed by the first level sensor 160 and is communicated to the signal processor/determiner 126 by the first 150 of the at least one signal inputs. Signal processor/determiner or microprocessor 126 generates a signal to solenoid 100 via signal line 161, which opens the valve 100 and allows the material to flow into microwave containment heating chamber vessel 122, more specifically into the fluid holding vessel 106, via entry port 105 until second level sensor 146 via signal line 148 generates a signal to microprocessor 126 that the fluid holding vessel 106 is full. Microprocessor 126 then generates a signal via signal line 161 to solenoid 100 to close and causes the material flow into microwave containment vessel 122, more specifically into the fluid holding vessel 106, to cease.

Microwave containment vessel 122 consists of material holding cavity or fluid holding vessel 106 and lid or cap 104, a level sensor 146, level sensor 160, exit port 107 for the steam, an entry port 105, and outer shell or microwave reflector 144. It can furthermore consist of a material stirrer 162 and temperature sensor (not shown). The temperature sensor can monitor the temperature of the water actively (not shown) for either displaying or actively controlling some function of the system. Material holding cavity or fluid holding vessel 106 is made of a material that is transparent to the frequency of the microwaves being generated and can take the pressures and temperatures of the materials being heated and in contact with its interior surface. Because of the cycling of the cold water and the subsequent heating into hot water that occurs this material should be resistant to temperature cycling. This type of material can be Pyrex glass or other glass or material that fulfills these requirements. Pyrex is the trademark name for any class of heat- and chemical-resistant glass of different compositions depending on the needs and requirements of strength, weight, temperature cycling, smoothness, and other mechanical and reliability requirements. Pyrex® glass was developed by the Corning® Glass Company and was labeled Cornining 7740. It is lead free and labeled a borosilicate type of glass. It was developed for its ability to withstand thermal shock created by sudden shifts in temperatures and its strength. It typically has a composition that has high resistance to strong acids or alkalis. The strain point is 510° C., annealing point of 560° C., and softening point of 821 ° C. makes it applicable to high heat applications. The typical composition is 80.6% SiO₂, 4% NaO₂, 13.0% B₂O₃, 2.3% Al₂O₃, and 2.3% K₂O.

Another Corning® glass, Corning® Vycor® 7913 would also be a contender to use for the fluid holding vessel 106. Pyrex glass can also be used as a generic term for borosilicate glass types used in the glass industry, but when used in reference to Corning® glass is a registered trademark.

Because of its composition and lack of any hydrocarbons in its formula, Pyrex glass is “transparent” to microwave energy. That is, the glass does not absorb a significant amount of energy, if any, into its bonds of matter from the microwaves penetrating its matter and passes the microwaves through its matter. The usual heating of Pyrex glass in a microwave operation is in the contact of the fluid or matter that is held within and in contact with its surface and the temperature flow from the heated matter to the glass containment vessel.

In addition to glass, glass that can withstand a cycle of heating and cooling, one embodiment being Pyrex, it is contemplated that other materials for making the fluid holding vessel 106 are possible, which includes plastic material, carbon fiber material or ceramic material. The antenna chamber 123 can be glass, Pyrex in one embodiment, but embodiments can use alternative materials which include plastic material, carbon fiber, or ceramic material, of which all would necessarily be transparent to microwave frequencies chosen for the application.

Pyrex is a good candidate for an embodiment because it is a smooth surfaced glass that has no pores and absorbs nothing so when it is cleaned it will not contain or transmit viruses or bacteria, nor will the surfaces be attacked by viruses or bacteria to scar the surfaces. However, because of these qualities, it does not contain a boiling point on its surface that can be used to start the water boiling process. Thus, a boiling point would be advantageous to be introduced into the fluid holding vessel 106 in some manner. One solution would be to cause the surface of the interior to be roughened, causing boiling points. Another solution is causing the shape of the fluid holding vessel 106 to be irregular that will cause nucleation sites due to the geometry of the vessel. Another solution would to have a stirrer causing the fluid or matter to be stirred by stirrer 162. Stirrer 162 is a motor, shaft and propeller. The motor would be on the outside of the fluid holding vessel 106 while the shaft penetrated the microwave vessel 144 and the propeller is on the inside. Another solution would to use a magnetic stirrer that is moved around by the introduction of a magnetic field. Another solution would be to have a device that is sensitive to microwaves and becomes excited and moves around when the microwaves are impinging upon it when the microwave source is emitting microwaves into the fluid containment vessel 106. A still further embodiment is to have the boiling point provided by a device carried in the fluid holding vessel 106.

Fluid holding vessel 106 is shaped so that an antenna chamber 123 is formed in the fluid holding vessel 106 for the insertion of an antenna 108. The antenna 108 can be directly connected to the microwave generator 110 or be remotely connected to it via a co-axial cable for transmitting the energy from the source 110 to the antenna 108. Furthermore, antenna 108 can be of the length and size that is determined to be best for the usage. For instance, the antenna 108 can be a quarter wave, half wave, full wave, or multiple wavelength antenna. The antenna length is dependent upon the frequency used for the microwave generator source. For a 2.5 Ghz microwave, the quarter wavelength is 1.1232 inches, for the half wave it is 2.2464 inches, and the full wavelength is 4.4928 inches. For a 10 Ghz signal the quarter wavelength is 0.2808 inches, the half wave is 0.5616 inches, and the full wave is 1.1232 inches. These configurations would give the best transfer of energy into the material in the fluid holding vessel 106. The fluid holding vessel 106 should be designed such that the distance from the antenna to the microwave reflector 144 is exactly a multiple of the wavelength distance. For example, if a quarter wave antenna were used, it would be beneficial to use a quarter wave, half wave, full wave, or some other multiple of the wavelength distance to the reflector 144 The microwave/antenna 108 can also be designed to be a microwave diode operating at a predetermined frequency, of which the output is sent to a power amplifier that then sends the amplified signal to the antenna 108.

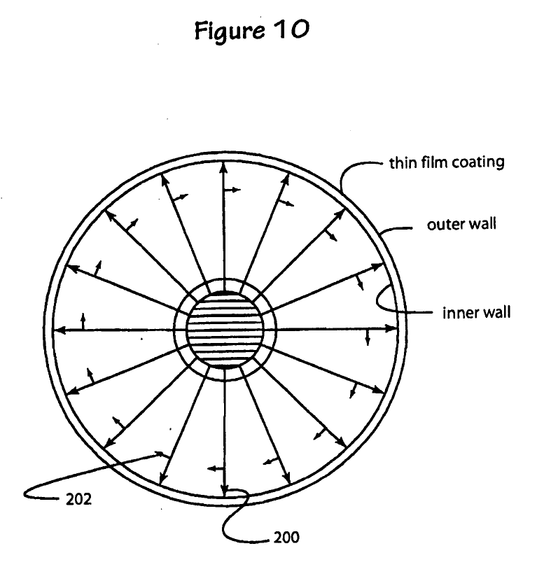

FIG. 10 is a top view of the antenna 108 inserted into the cavity of the fluid containment vessel 106 showing the emanation of microwaves from the antenna and their direction. The type of antenna shown illustrated is a monopole antenna with linear polarization that radiates in a circular pattern and has a typical half power beam width of 45°×360°, as shown in FIG. 15.

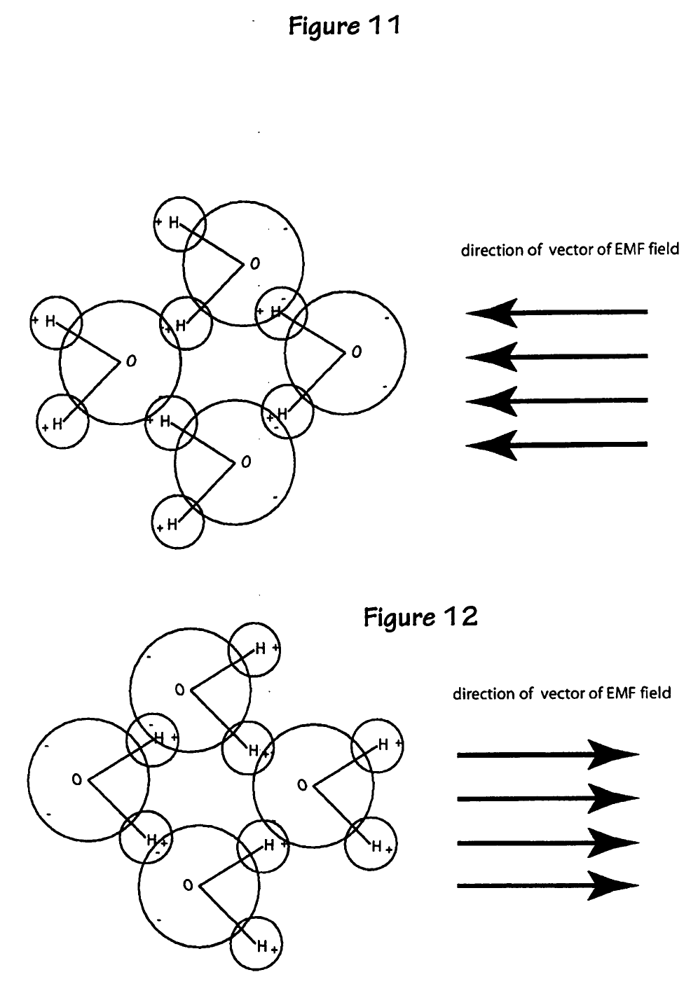

In an RF field that is generated by a microwave source with a monopole antenna the field vectors of the electric and magnetic components will oscillate. This oscillation can either be a rotation of the direction of the field vectors or the amplitude of the field vectors. The direction of the wave propagation stays the same but the intensity of the electric and magnetic components will cycle as a periodic function of time in a polarized beam. Because the EMF wave is a sinusoidal function the magnetic and electric field vectors vary as a function of the periodicity of the time of the wave. As seen in FIG. 7 the electric and magnetic field vectors are all at right angles to one another and to the direction of travel of the wave. In a polarized field the direction vectors of the magnetic and electric fields remain a constant. That is, they lie in a direction that defines a single plane, each plane being at right angles to one another. This externally created polarized field can initially cause an alignment of the water molecules as such shown in FIG. 11, or cause the molecules to try and align themselves as such. The oscillating field first causes them to try and align as shown in FIG. 11 then again as the field oscillates as in FIG. 12. This flip-flopping causes the bonds to vibrate at higher frequencies, taking on energy (thus raising the temperature of the water) and eventually putting enough energy into the bonds whereby the bonds between the water molecules are broken. It is similar to the repeated stretching and relaxing of a rubber band, causing it to heat up and eventually fail. They are “broken” because the individual water molecules have absorbed energy into their internal structure to the point where they are at a temperature where the external bonds between water molecules are not germane, or too energetic to form.

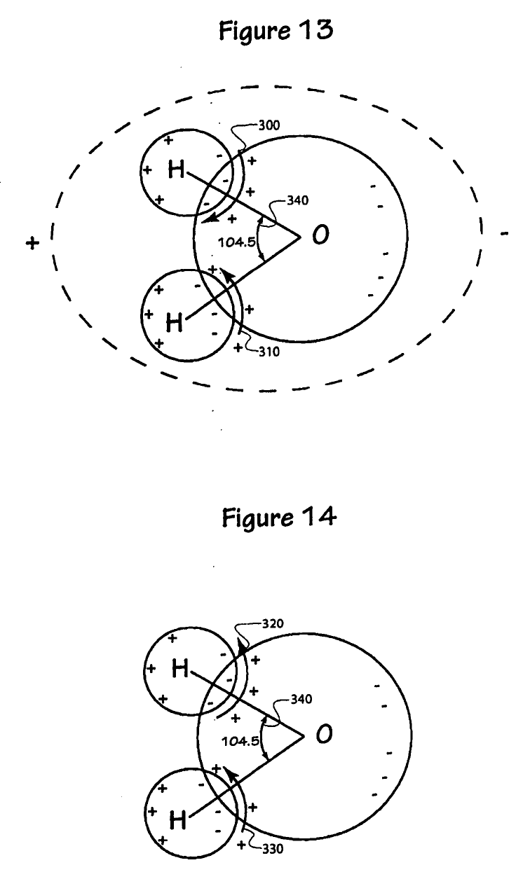

As explained previously, molecules, and atoms try to seek the lowest energy level possible. By referring to FIG. 13, which is a simple diagram of the hydrogen-oxygen molecule showing the two hydrogen atoms with the oxygen atom that makes water have its properties. The angle 340 between the two hydrogen atoms is 104.5°. One of the possible rotations of the bonds between the hydrogen and oxygen is shown in the FIG. 13. Notice how the spin 300 of one hydrogen bond counterbalances the spin of the other hydrogen bond 310, resulting in the lowest energy required to maintain this bond, and resulting in a more stable water molecule, albeit the water molecule is still polar and interacts with other types of molecules to form new molecules with different properties. It is said that water is the best solvent ever invented.

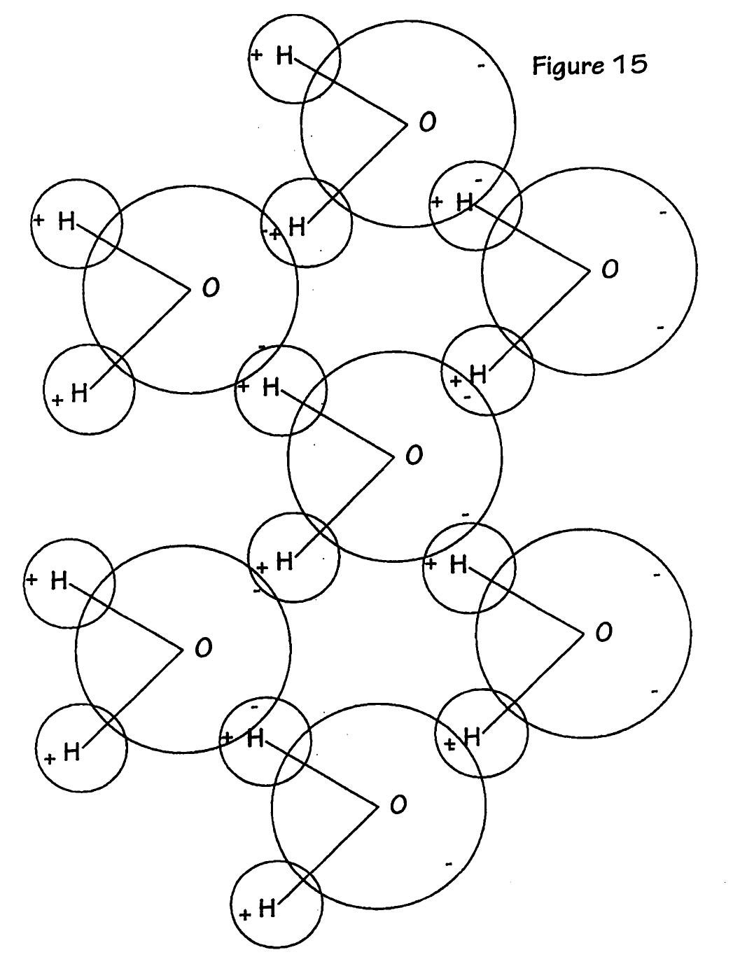

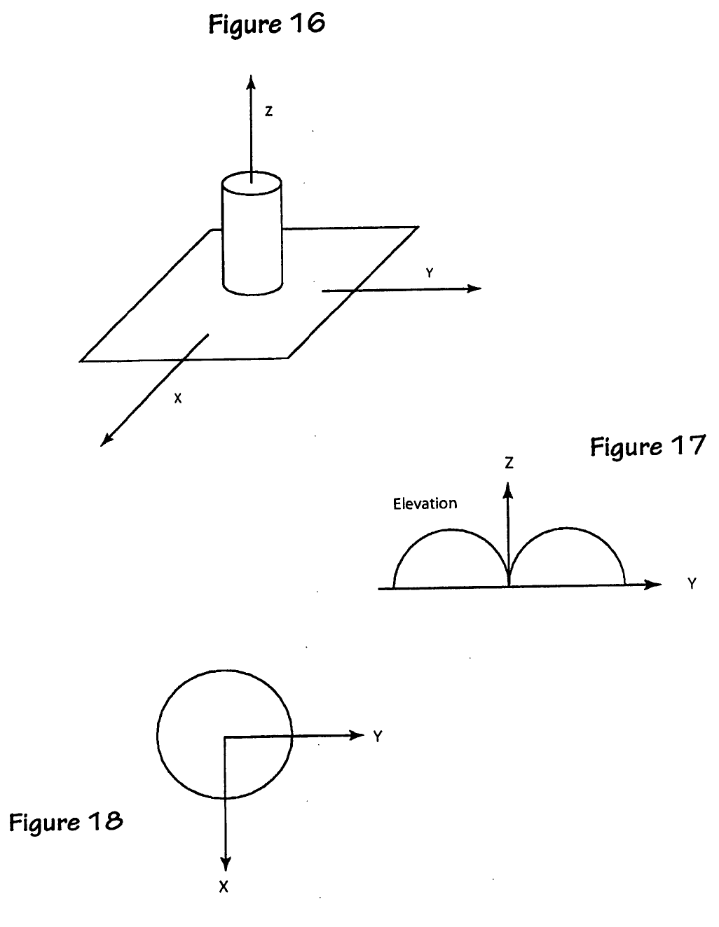

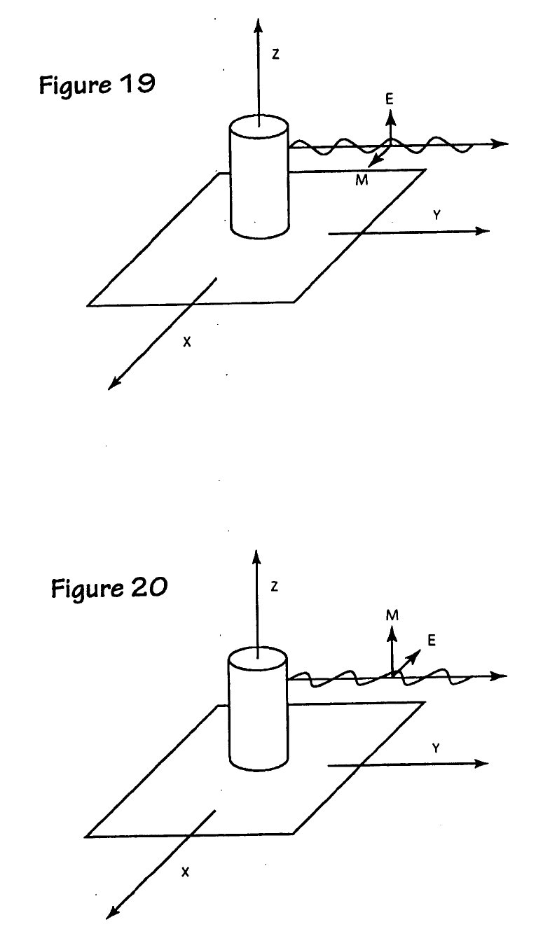

However, in the presence of an external polarized EMF field (RF field) the spins of rotation of the hydrogen bonds between the hydrogen and oxygen atoms will try and align themselves as in FIG. 14 when the right conditions occur. This alignment produces a slightly more “aggressive” water molecule. The water molecule has very slightly different physical properties, but will interact with other types of molecules much more readily. Because the spins of rotations of the hydrogen-oxygen bonds 320, 330 are in the same direction the water is in a more aggressive mode of wanting to reduce its energy level to a more balanced one where the spins counterbalance one another. Thus the water molecule will interact with other molecules in different and new ways, but still maintain the physical characteristics of water. It will still be polar, but with a very slight different center of momentum. The hydrogen bonds, rotating in the same direction, will have more of a pronounced effect upon other substances because their momentums (spins) are not canceling one another out. The polarity of the water molecule will be more pronounced. This could further cause a change in the bonding angle 340 between the hydrogen atoms and the oxygen atom. It should be understood that all molecules do not align themselves as in FIG. 14, but only a certain percentage. This is due to various factors, such as the strength of the microwave field (EMF), the amount of polarization, the design of the fluid holding vessel 106 the pressure of the steam and the amount of time the molecules are subjected to the microwave field before leaving the vessel, the amount of steam subjected to the microwave field, etc. The amount of aligned molecules are also a function of the laws of probability of the dynamics of particles and the recombination into water and the speed and temperature that this happens. Thus the amount of water aligned by this process can be between 0% and 100% depending upon the conditions.

In fact, these characteristics have shown themselves in testing of this water in making beer, wine, breads, pastas, etc. The water dissolves other molecules more aggressively than other distilled water, and has reduced the time to manufacture beer by ⅓ to ½. It has reduced the time to manufacture and mature wine by months, if not years for the maturation of the wine. Furthermore, several of the chemicals to manufacturer these substances were omitted because they were no longer necessary, such as Irish moss and sulphite.

Microwave reflector should be designed such that the material used reflects the microwave energy not absorbed by any of the water molecules is reflected back into the water for further absorption. It can be a metallic material or coating. Thin film coatings are also referred to as dielectric films, i.e., they are films made of materials composed of atoms whose electrons are so tightly bound to the atomic nuclei that electric currents are negligible even under applied high electric fields. The individual film thicknesses or layers vary over a very broad range, but they are referred to as a thin film when the thickness of the film is on the order of that wavelength. These films are built up in many layers, one on top of another, and are referred to as a multilayer thin film. Each layer then reflects the appropriate wavelength or orientation of the electric field vector according to its individually designed construction. These layers are typically deposited on top of a receiving substrate by vacuum deposition. This includes vaporizing a material and causing the vapor atoms to strike the substrate in a predetermined manner and rate. Some typical materials are MgG2, Si2, Al 203 C (diamond), ZnS, TiO2, CdS, CdTe, GaAs, Ge, Si, Ag, Au, PbS, along with many materials.

When dielectric materials are used, the index of refraction for each layer is different from each adjacent layer, although in some they might be the same.

Depending upon the material chosen for the thin film and the thickness of the thin film, different results are achieved. A device made in this fashion can have from one to several hundred film layers on a substrate.

Another method for an alternate embodiment would be the coating of a reflector onto the surface of the fluid holding vessel with either paint or to coat a metallic paint or epoxy onto the exterior surface. A coating used successfully in the proto-type functioning device was a high purity silver paint for scanning electron microscopy sample preparation by SPI, product number 05002. This paint had a high percent of silver solids. This paint was painted on by hand in one instance and sprayed on in another instance. A very thin coat was applied. After this coating another coat of copper paint was applied on top of it. This paint was advertised as an EMF shielding and conductive paint, with a name of CuPro-Cote Paint. It was a water based air dry one component paint with a 57+3% by weight solids composition. Again, this paint was applied in one instance by a brush and in another instance by a standard paint air gun. The vessel, a Pyrex fabricated container, was then dried in an oven for approximately 2 hours at 200° F. The attenuation is advertised as 0.75 db from 1 MHz to 1 GHz. All of the fluid holding vessel was coated with this two layer process and a reading was taken with a microwave field meter at a distance of 1 meter with a reading of less than . . . , which is considered a safe level for home microwaves. Thus the external coating system was successful. Again, this method of applying an EMF coating could be utilized by sputtering, deposition, or ionic attraction to the surface, or any other method of applying a EMF shield to the outside of the vessel.

Silver was chosen as the inner coating (the coating first applied to the external surface 121 of the fluid holding vessel 106) because of its properties of EMF shielding of microwaves. None of the coating was applied to antenna chamber 123. Antenna chamber 123 was masked off specifically to prevent any coating to get applied to its surface.

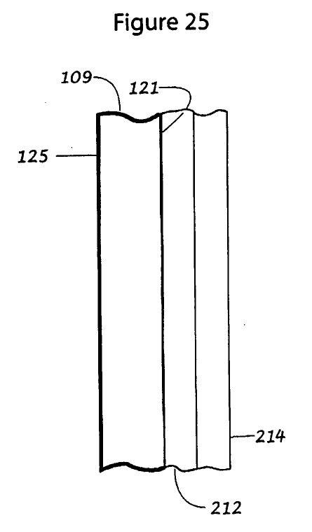

Microwave shielding can take several forms, but basically can be broken down into reflective or absorptive methodologies. In the reflective method, the shielding reflects the microwaves impinging upon the surface of the reflector according to law. This states that the angle of the incoming wave relative to the surface is the angle of the reflected (outgoing) wave relative to the surface, as illustrated in FIG. 25. “Known as the law of reflection, it first appeared in the book titled Catoptrics, which was purported to have been written by Euclid.” Hecht, Optics, Second Edition, incorporated herein by reference. It is also now commonly known as Snell's Law in English speaking countries. Waves travel through space that is occupied by matter. When the volume of matter changes in composition to another composition of matter, it is referred to as an interface, or surface of an object. When a wave hits a surface of an object it is reflected and refracted. The amount of reflection and refraction and their respective percentages depend on many, many factors. Typically a substance is a very good reflector for a particular group of frequencies and very poor for another group of frequencies. Refraction refers to the wave penetrating the volume of the second composition of matter and traveling through its medium, but the direction that the wave was traveling is altered, and can be attenuated or accentuated.

The microwave reflection also has several factors involved other than the type of material, such as the surface roughness or smoothness, shape, size of surface particles in relation to the wavelength of the impinging wave, etc. With microwaves, the interactions are complicated because the wavelength is in the same size range as the particles composing the matter. Metallic objects are good microwave reflectors because of their high electric conductivity. Silver is the best electrical conductor of all metals with a conductivity of 6.21·10⁻⁷/Ωm, copper has a conductivity of 5.88·10⁻⁷/Ωm . Electrical conductivity is a measure of how well a material accommodates the transport of electric charges. The more mobile the electrical charges are for a particular composition of matter, generally the better the matter is for a microwave reflector, depending upon the other factors of surface roughness, particle size, shape, etc. Furthermore, these metals act as good thermal conductors and can dissipate the energy as heat. They also tend to be infrared reflectors, reflecting the heat back into the fluid holding vessel 106.

Thin films are made of layers of metallic materials and can be utilized by coating the outer surfaces of the fluid holding vessel 106. The thin film coatings on the first layers should be optimized for the best reflection of the microwaves back into the vessel itself. The reflector or other shielding or shielding layers can be connected to a ground so that the microwaves energy has a low or zero potential value of electrical energy relative to the ground. This should also apply to the microwave generator source 110 to prevent any electrical shock. One of the advantages of a thin film coating on the fluid holding vessel 106 is that it can follow and be suited to the geometry of the vessel. It also would be durable and lightweight. Either Physical Vapor Deposition or Chemical Vapor Deposition can be used to apply the thin film layers for an embodiment of the invention. Other methods that are suitable to coat or cause the fluid holding vessel 106 can also be utilized. In an embodiment of the invention the fluid holding vessel 106 could be a contiguous vessel, i.e., the cap or lid 104 is actually part of and made of the same material. That is, the fluid holding vessel 106 would be an enclosed vessel with entry port 105, exit port 107, optional entry port 116, and exit port 152, which can be optional or built-in, formed into and be part of the vessel. The antenna chamber 123 can also be formed this way.

In an alternative embodiment, antenna chamber 123 above would not be part of the contiguous vessel, but a separate formed vessel or chamber that is inserted through a wall of the fluid holding vessel 106 and is then secured. A gasket could be placed between the antenna chamber 123 and fluid holding vessel 106 to secure a seal that is leak proof. Furthermore, a provision for attaching the antenna chamber 123 to the fluid holding vessel 106 could be provided, such as a locking nut, latches, etc. Any device that would secure the antenna chamber 123 securely in place within fluid holding vessel 106.

In another embodiment the fluid holding vessel 106 could have an opening in the top, to which a lid or cap 104 can be secured. The lid or cap 104 could have a seal to form a leak proof connection between it and the fluid holding vessel 106. Furthermore, it can have a method to attach it to the fluid holding vessel 106 such as screwing it on, using latches to securely hold it in place, clamps, etc. Any device that secures the lid or cap 104 securely in place with fluid holding vessel 106 can be used. The entry port 105 or exit port 107 can be formed into the lid or cap 104 or into the fluid holding vessel 106, as well as other entry/exit ports.

An alternate embodiment of the invention has the microwave source 110 and the antenna 108 able to be removed or swung out of the way to gain access to fluid holding vessel 106 in order to facilitate the removal of the fluid holding vessel 106 for maintenance and/or cleaning. Furthermore, fluid-holding vessel 106 can be made to unscrew or disconnect from the lid or cap 104 for replacement if necessary.

An alternate embodiment used the invention described herein for the processing of water with cubic zirconium diamonds placed in the interior of fluid holding vessel 106 placed in the water held within the vessel. It was noticed that the cubic zirconium diamonds created good nucleation points for the water to start boiling at. The cubic zirconium diamonds are transparent to microwave energy at 2.5 GH_{z} and do not display any deterioration of physical properties. The water started to boil at these cubic zirconium diamonds and formed steam bubbles that ascended to the top of the water and left the body of water as steam.

A boiling point on the surface of the material holding cavity 106 of the fluid holding vessel 122 is mentioned above. Another embodiment of a boiling point may be formed by shaping the surface of the fluid holding vessel (also known as the material holding cavity) 106 of the microwave containment vessel 122 as an irregular shape causing nucleation sites.

At this point in the cycle, when the microprocessor 126 has determined that the water in the fluid holding vessel 106 is full it will then generate a signal on signal line 128 that causes relay 134 to switch the power on to microwave source transformer and capacitor 140 to energize the microwave generator 110 and emit microwaves via antenna 108 through the antenna chamber 123 walls and cause the water inside the fluid holding vessel 106 to be heated. Also, at this time in an alternate embodiment the water stirrer 162 is operated by relay 138 via power line 164.

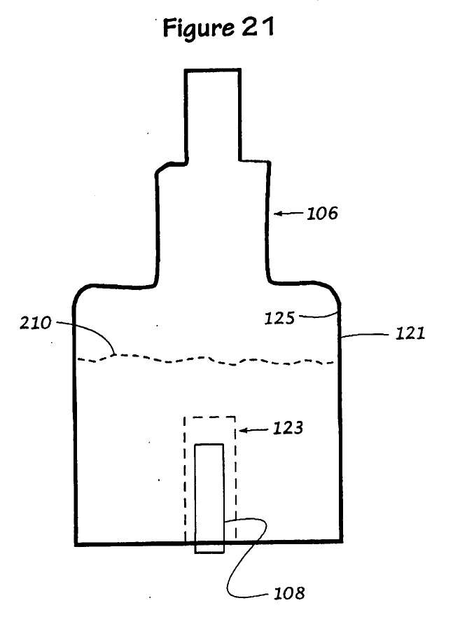

In an embodiment of this invention water flows into the fluid containment vessel 106 until the water level indicated in FIG. 21 is obtained by level sensor 146 indicating it is full. In the prototype the fluid containment vessel 106, illustrated by FIG. 21, was filled with 1500 ml of water, with an air space 342 existing above the water level in the fluid holding vessel 106, and then the microwave cycle began. The air space could accept another 1000 ml of water before coming out of the input port 105. The microwave cycle began when microwave source 110 was energized by the transformer/capacitor/diode circuitry 140 and emitted microwaves through the walls of the antenna chamber 123 via antenna 108 into the water held within the material holding cavity 131 of the fluid holding vessel 106.

The prototype fluid holding vessel 106 was coated first with a silver paint made by SPI, and then another layer of copper paint was applied on the first coat of silver paint. Fluid holding vessel 106 had a silver paint coating 212 applied to the external surface 121 first. After this coat had dried, a coat of copper paint 214 was applied onto the silver paint. The copper paint coating 214 was purchased from LessEMF.com, 809 E. Madison Ave., Albany, N.Y. 12208, USA. It is named CuPro-Cote™ Paint. It is advertised as a sprayable, brushable, or rollerable conductive metallic coating using a specially formulated copper as the conductive agent for superior performance in electric field and RF shielding. It has surface resistivity of <0.3 ohm/sq. at 1 mil dry thickness. The attenuation is more than 75 db from 1 MH_{z} to 1 GH_{z}. Tested for stability up to 160° F. The silver paint coating 212 was acquired from Structure Probe, Inc. (“SPI”), P.O. Box 656, West Chester, Pa., 19381-0656. It is named SPI Conductive Silver Paint, has a high percent of silver solids and dries uniformly. Silver does not melt until 961° C., but its useful temperature range is below this temperature. The conductivity of the dried film was 10⁻⁴ ohms per cm, with a surface resistivity of 0.5 ohms/area. This application prevented the silver paint coating 212 from tarnishing because one surface of the silver coating 212 was against the Pyrex glass of the exterior surface 121of fluid holding vessel 106 and the other surface of the silver coating 212 was covered by the copper paint coating 214.

The water in the fluid holding vessel 106 is heated by the action of the microwave energy upon the molecules of H₂O. The water molecules, bonding to each other, as in FIG. 15 and FIG. 11 and FIG. 12, are subjected to the changing microwave field. This causes the polar water molecule, as seen in FIGS. 11, 12 and 13, to try and align in one direction as in FIG. 11, then in another direction, as in FIG. 12, making the water molecules accept energy into their bonds 300 and 310 and heat up. Below the temperature where water turns into a gas, the molecules can also temporarily break the weak secondary hydrogen bonds designated as dash lines in FIG. 22 and reform them again, staying in the liquid form. All of the water molecules are subjected to this microwave bombardment in fluid holding vessel 106, with any microwave energy not absorbed by the water molecules traveling through the water, through the walls 109 of the fluid holding vessel 106, impinging upon the coating of microwave reflector 144 and is returned (the wave) back into the water held in the material holding cavity 131 of the fluid holding vessel 106. All of the water in the material holding cavity 131 has its energy level raised by the microwave absorption, thus the temperature increases. This is different than the microwave water heater of Johnson, et al., International Patent Number WO87/05093, whereby only a portion of the water is subjected to the microwave heating action and the transfer of energy (the rise in temperature) to the remaining volume of water is dependent upon convection and conduction. Furthermore, Johnson, et al., has his microwave reflector 144 inside of fluid holding vessel 106, which subjects it to the corrosive action of water, and contaminating the water itself. Also, Johnson, et al., does not use the device in their disclosure for generation of steam and illustrates or discusses no air space 342 within fluid holding vessel 106.

As the water in fluid holding vessel 106 is raised in temperature (the vibrational energies of the bonds are increased) the bonding between the water molecules are weakened, or become less strong. When the water in fluid holding vessel 106 reaches the temperature where water molecules totally disassociate themselves from other molecules, turning into steam, it was noticed that “explosive” occurrences were happening. These are water molecules expanding and turning into steam, a gas, in the body of the water. These explosions would eject matter (water) and cause hot water to be injected into exit port 107 and through line 112 and into the condensation coil 124 without having ever turned into steam. To prevent this from happening, since one of the objects of this invention is to purify water by distillation, an air space 342 above the water level 210 in fluid holding vessel 106 is allowed to exist. This is shown in FIG. 21, as is the approximate level of water 210 in relation to the antenna 108. When the explosions occur in fluid holding vessel 106 shown in FIG. 21 they do not send water down exit port 107, but rather explode into the air space 342 above the remaining water body and the water then falls back down.

The influence of the microwaves upon the water body turns a portion of the water into steam that escapes from the fluid holding vessel 106 via exit port 107. While this water, which is now steam, disassociates from other water molecules it is still under the influence of the microwave field, illustrated in FIG. 10. A portion of these molecules, because of the excited state they are in, along with their bonding between the hydrogen and oxygen atoms, are susceptible to having their hydrogen-oxygen bond spin rotation changed to the state shown in FIG. 14, where the hydrogen-oxygen bond spin 320 and 330 are aligned, as opposed to FIG. 13 where hydrogen-oxygen bond spins 300 and 310 are not aligned but spin in a state caused by the lowest energy of formation. The water molecule in FIG. 14 is in a higher energy state than that of FIG. 13, even though the temperatures are the same. This causes the water molecule of FIG. 14 to be more reactive and have slightly different properties than the water molecule of FIG. 13, accounting for its ability to speed up processes or react different than normal tap water or even reverse-osmosis or distilled water, as mentioned later.

The water molecule turns into steam at 212° F. and creates a greater pressure on the air in the air space 342. Steam (vapor) exits via exit port 107, toward a lower pressure. In another alternate embodiment the pressure in fluid holding vessel 106 could be regulated and cause the water to boil at a higher temperature by restricting the flow out of exit port 107 by either sizing the line 112 and/or exit port 107. In another alternate embodiment the water could be caused to boil at a lower temperature by decreasing the pressure in the line 112, and subsequent parts, for example a vacuum might be applied to collection holding vessel 120.

The explanation for the purity of the distillate produced is water has a lower boiling point than the other matter left behind, such as contaminants of heavier matter that have a higher boiling point. The water is first to turn into a gas and escape the fluid holding vessel 106. With the contaminate matter disassociated from the water molecule and its bonds, the atoms or molecules of the heavier compounds are left behind and gravity causes them to fall toward the bottom of fluid holding vessel 106. There the contaminates precipitate out or are rejoined into the remaining water body by reacting with the remaining water (liquid) molecules. Any compounds of lighter volatile compounds that turn into gas at a lower temperature than water are generally smaller molecules than water. A small hole in exit port 107 or line 112 that is smaller than the water molecule in the steam state would allow these compounds or molecules to escape while still keeping the steam exiting the device by line 112 towards collection holding vessel 120. The calculation of energy required and the efficiently of the distillation of water, specifically the conversion of room temperature water into steam is as thus:
1) 1500 ml of water at 22.2° C. is heated by microwave energy to a temperature of 100° C. in 30 minutes, and of that 1500 ml original water, 500 ml is converted to steam.
2) 1500 ml of water is approximately 83.3 moles of water, where 1 mole equals 6.023·10²³ molecules
3) 1 mole of water, which is 2 moles of hydrogen and 1 mole of oxygen, weighs 18 grams
4) The density of water is 1 gram/cc, therefore 1500 ml(cc) weighs 1500 grams
5) 1 calorie is the amount of energy required to raise 1 gram of water 1° C. at 15° C.
6) 1500 grams×77.8° C.=116,700 calories=487,806 Joules
7) The latent heat of vaporization for water is 2260 KJ per liter. Therefore 0.5 liter×2260 KJ/liter=1130 KJ
8) Total energy required equals energy to raise 1500 ml of water to 100° C. added to energy to raise 500 ml of water in liquid phase to gas phase is:

487,806+1,130,000=1,617,806 joules.
9) Energy gained by each molecule of water by heating to 100° C.

$$7 \text{,} 806 joules = 3.0446459 \cdot {10}^{ 24} ev$$

$$\frac{3.0446459 \cdot {10}^{24} ev}{83.3 \times 6.023 \cdot {10}^{23}} = .0671 ev$$
10) Energy gained by the 500 mls of water molecules by conversion to steam from liquid at 100°

$$1 \text{,} 130 Kjoules = 7.05290 \cdot {10}^{ 24} ev$$

$$\frac{7.05290 \cdot {10}^{24} ev}{27.8 \times 6.023 \cdot {10}^{23}} = .421 ev$$
11) 1 joule=6.24150974·10¹⁸ev
12) total energy gained turning to steam by molecule of water=0.421 ev+0.06071 ev=0.481 ev
13)

$$1 watt = \frac{1 joule}{second} therefore$$

$$\frac{1 \text{,} 167 \text{,} 806}{30 min} = \frac{1 min}{60 sec} = \frac{898.78 joules}{sec} = 898.78 watt$$
14) Using a 1.5 kilowatt microwave tube consuming a total of 1.8 kilowatts the

$$efficiency = \frac{898.78}{1800} = .499 or about 50 \% efficiency$$
15) The above efficiency is for the first batch of water made. After the next 500 ml is put into the fluid holding vessel 106, and having been preheated, the efficiency of the system rises because it takes less time to preheat all of the water and approximately 20 minutes to distill the next batch of water. Thus

$$\frac{1 \text{,} 130 \text{,} 000}{20 min} = \frac{1 min}{60 sec} = \frac{941.67 Joules}{sec} = 941.98 watts are consumed$$
16) The efficiency changes to

$$\frac{941.78}{1800} \approx 52 \%$$
17) The energy gained by one mole of water is:

$$\frac{1 \text{,} 617 \text{,} 806 joules}{83.3 moles} = 19 \text{,} 421 joules or \approx 19.5 KJ$$

Only a small portion of the water turned into steam and collected in collection holding vessel 120 has the alignment of water for the hydrogen-oxygen bond spins 320, 330 as shown in FIG. 14. This amount of water that has been changed is regulated by the total overall exposure to the microwave field in time and strength, by pressure, by boiling point, by the amount of time it is in the steam state and the strength and time of exposure, and by other factors. Furthermore, reprocessing the water already distilled causes a larger population of the molecules to have their hydrogen-oxygen bonds spins realigned, causing this re-processed water to behave more aggressively and having slightly different properties. The water was reprocessed up to ten (10) times by running the water back through the device, and each level of reprocessing shows different characteristics. Different embodiments to accomplish this will be discussed below. The amount of reprocessing strictly would depend upon what is to be accomplished, and is unlimited. The purity of the water increased by the reprocessing, but not as much as the change in the properties. Water that was purer than the water produced by this device did not show any advanced properties that this water has. The explanation for this is that the number of aligned hydrogen-oxygen bond spins increases as the same water is exposed to the microwave fields a longer amount of time. For example, the first time the water is distilled, the spin-rotation alignment occurs in 0.2% of the water molecules. The next time this same amount of water (in the prototype it was 500 ml) was run through the device 0.45% of the water molecules were spin-rotation aligned totally, or a gain of 0.25%. The next cycle yielded a total of 0.7% total of aligned water molecules. And it keeps increasing every time the cycle is repeated on the same water. It should be appreciated that these numbers were used for this example, and the quantative amount represented was used merely for example.

It is reasonable to think that the hydrogen-oxygen bond spins can influence the nucleus particles, or the change in nucleus particles can change the hydrogen-oxygen bond spin. One influences the other. Since the hydrogen-oxygen bond spin depends upon the electrons of the oxygen to be shared with the hydrogen, it is reasonable to believe that the electrons could have their spin realigned in concert with the microwave field. Since it is postulated that one of the functions of the electrons is to “guard” the nucleus of an atom, it is believable that there is an interaction between the electrons and nucleus by a force. If this force is changed by direction, then it will exert a force on the nucleus, and therefore the nucleus particles, the quarks. This could come in a form of realizing spins of some of the quarks, realigning how they spin in regard to one another, or how one spins in relation to the others, how they interact with regards to emitting other particles, their charge distribution, etc.

What this does is redefine the Periodic table of elements, such that it can now become three-dimensional. The third dimension is an explanation, or table, of the spin direction of the quarks

and/or electrons. For instance, in helium, which has two electrons and two protons, one could define one helium with a spin of each of the electrons opposing each other (lowest state of energy) while the next helium, as having the electrons in the state where both electrons are spinning in the same direction (aligned) and having a higher energy state. It also further explains why the elements are more reactive on the left side of the table (unbalanced electron spins), that is, an odd number) as opposed to the right side of the Periodic table where the even number of electrons can have equal spins right and left canceling one another out. However, by changing the ratio of the number of electrons with right and left spins a higher energy atom can be created that is more reactive to other atoms. It could even be conjectured that in the future the individual electrons in an atom can have their individual spins manipulated so that the individual atom has a peculiar property desired. Thus, for instance, electron 22 in the Krypton atom, in shell number 3 (energy level) has its electron spin changed, so there is now 19 electrons with a left spin and 17 electrons with a right spin, and this makes the Krypton atom reactive with the hydrogen atom, where before it was not.

Furthermore, this electron spin could explain the necessity for the number of neutrons added to the nucleus with protons. Because of the way the electrons spin and create a shell around the

nucleus, interacting with it by forces, the neutrons are a regulating force in regards to keeping the nucleus balanced in regard to the momentum and center of gravity, however, they would (and do) have no charge so that they do not exert a force in regard to electrical attraction or repulsion or any other particles, i.e., the protons or electrons.

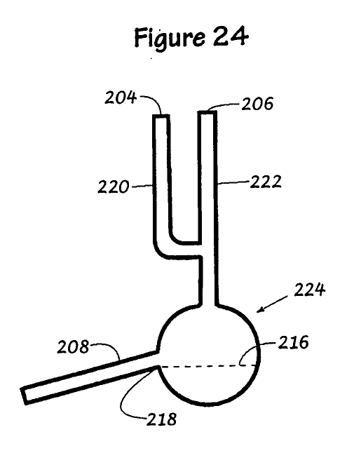

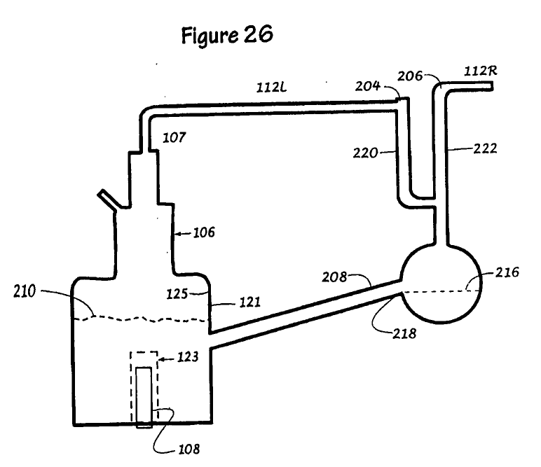

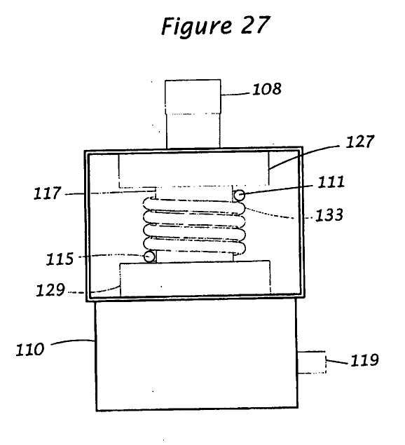

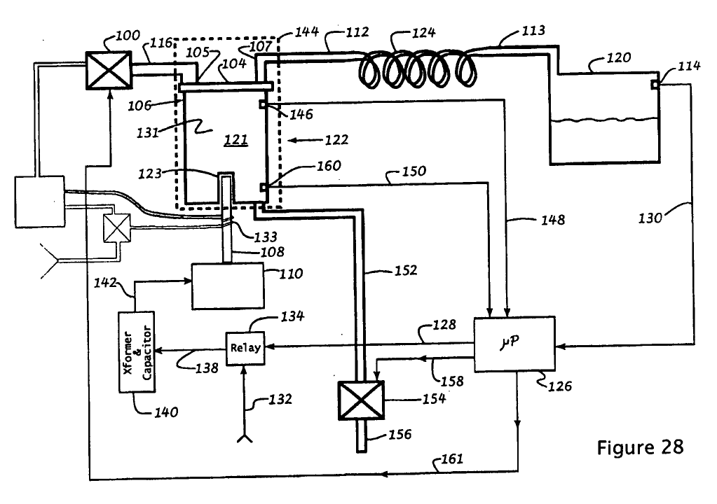

Water is heated above its boiling point and turns into steam, whereby it exits the fluid holding vessel 106 by exit port 107, through line 112 and enters into the condensation coil 124. The coil of tubing 124 can either be cooled by blowing air across it or by using the incoming water to cool the condensing coil 124. Also, the coil 124 can be made out of copper, stainless steel, plastic, ceramic, etc. It is in this condensation coil 124 that steam is converted back to water again and is deposited through line 113 into collection holding vessel 120. It would be advantageous, but not necessary, to have a charcoal filter in the line 113 between the condensation coil 124 and the collection holding vessel 120. In an alternative embodiment another vessel, secondary vessel 204, as shown in FIGS. 24 and 26, can be placed between exit port 107 of fluid holding vessel 106 and condensation coil 124 in line 112 by separating line 112 into line 112L and 112R, as shown in FIG. 26. Line 112L would be connected to steam outlet port 206. Water feed back line 208 would be connected to fluid holding vessel 106 as shown.

The microprocessor 126 is continually checking level sensor 114 and level sensor 146 and level sensor 160 to see if the operation should be stopped at anytime. When level sensor 114 indicates that holding vessel 120 is full, then no further distilling operations will take place until level sensor 114 then indicates that it is below the level and needs more water to fill up. Instead of level sensors a mechanical float can be used.

Also, microprocessor 126 will distill water until such time that sensor level 160 indicates via signal line 150 that the fluid has been evaporated and at that time microprocessor 126 will then send a signal via line 128 and turn relay 134 off, which in turns stops the power to the microwave transformer and capacitor 140 which then stops microwave source 110 to stop emitting microwaves. It will also stop material stirrer 162 from turning, however it would be advantageous to have stirrer 162 to keep turning for a predetermined amount of time. This can be caused by either an external circuit, another and separate relay from the microprocessor 126, or by the motor and capacitor connected to the stirrer 162.

When the process is actively boiling and distilling water the microprocessor 126 can monitor the rate of evaporation and/or collection in the different vessels. By varying the frequency of the microwave source and using the above information the microprocessor can determine what is the best frequency for the best efficiency of the system and self adjust to this frequency on a predetermined basis. Thus the system can be a self-adjusting system for the maximum efficiency by using feedback.

Furthermore, when the microprocessor 126 has processed a predetermined number of water boils from the fluid holding vessel 106 the microprocessor 126 can then initiate a cleaning cycle for the fluid holding vessel 106. It does this by causing the vessel 122 to be filled, heated to a certain temperature, and then causing this water to be discharged through line 152 into a disposal water line 156 controlled by solenoid 154 that is further controlled via line 158 from microprocessor 126.

Another embodiment of the invention is shown in FIG. 26 where a secondary vessel 224 is added in line 112 of FIG. 7. Line 112 is divided into two lines 112L and 112R. The secondary vessel 224 is used for returning water back to fluid holding vessel 122 via water feed back line 208. Fluid holding vessel 106 would have another port, labeled water feed back port 209 as shown in FIG. 26. The heating of the water occurs as described above, along with the generation of steam and the charging of a portion of the spin alignment. The steam (or vapor of a material) that is energetic enough will exit out of fluid holding vessel 106 through exit port 107 and into line 112L, into steam (vapor) inlet port 204, be forced by pressure down inlet steam (vapor) line 220. At this point, if the steam (vapor) is still energetic enough (has temperature high enough) it will flow upwards through outlet steam (vapor) line 222 against gravity and out steam outlet port 206 though line 112R. Line 112R can be connected to cooling coil 124 or directly to a collecting vessel 120 that collects gas. Material (water) that did not achieve high enough temperature or energy to complete the trip upwards against gravity fall into the bottom of the secondary vessel 224. After the fluid level 216 builds up to a certain level from accumulated fluid, it will start flowing past the overflow point 218 down water feed back line 208 and into fluid holding vessel 106 through water feed back port 209. The fluid that flows back into fluid holding vessel 106 is then subject to the microwave/heating cycle over again as described above. This has the effect upon the overall distillate being more pure and with a greater percentage of spin-aligned water molecules than an embodiment of the invention without it. It in effect will reprocess a portion of the water or fluid again, while only allowing the lighter and more energetic particles to continue on.

Another embodiment of the invention utilizes several of the devices described above and shown in FIG. 1 and other described and referenced figures above in a series arrangement. That is, the collection holding vessel 120 can be connected to a second input pipe 102 of a second distillation device and be used as the source for supplying the water or fluid for a second device of this invention. The number of connections is only limited to the number of devices and the purity of or desired results that are wished to be achieved. Thus, for water that can be used for facial cleaning can be achieved by having seven (7) of these devices connected in series together.

Water for cleansing of the face, removing makeup, normal and waterproof, has been accomplished by reprocessing of this water six (6) times, for a total of seven (7) times distilled. It was noticed that this water cleansed without using soap, removed waterproof eye makeup, mascara, and removed wrinkles and blemishes from the skin. Furthermore, while my wife uses the water, she noticed that she did not sunburn where she had utilized the water on her face after a period of two (2) months. It creates smoother skin and appears to make the skin supple in some people who have used the water, and makes the skin feel more moistureous.

It has been conjectured that diseased cells have an abnormal energy to them compared with healthy cells. The inventor of the MRI (Magnetic Resonance Imaging), Raymond Domedian, M. D., believed that non-healthy tissues would emit different signals from healthy tissues. In actuality, there exists a difference in the relaxation times between healthy and non-healthy tissues in the human or animal bodies. In the 1930's, the physicist Isidor Rabe subjected nuclei to an external magnetic field and noticed that they could align themselves either parallel or anti-parallel. By bathing the nuclei with radio waves he was able to change, or flip, their orientation. It was two other scientists, Edward Purcell and Felix Black who showed that nuclei had two relaxation times, T₁ and T₂. Dr. Damadian tried to predict cancerous cells according to this theory, but it was Paul Lautebur who used two magnetic fields, one with a field that varied strength in a precise way, that finally proved this theory.

As previously explained, the nucleus of an atom consists of quarks that are bound together by the strong nuclear force, and it consists of a triad of them. They must go together in a certain fashion to obtain the lowest possible stable energy state, which I designate as [symbol] E, or the ground (reference) energy state of a nucleus of an atom. Since life on this planet is fairly new, particularly human life, while the materials and matter of this earth have been around for a much longer time. The matter of the outer portions of the earth have been able to go through the process I have described of lowering their energy states. Thus most of the matter has been reacted with, or reacts with, other matter to create matter that has formed into the [symbol] E energy state, including the matter that formed into human beings, including ourselves. Since we are living and breathing organisms, with live cells, our bodies are constantly going through changes, which we understand as chemical reactions, including our thought processes. The cells that form are in the energy state of [symbol] E, and are formed of cells that are in this same state. However, because of the toxic materials in our air, food, and water supplies, along with too much radiation from many and varied sources, even the sun, cancer seems to be more prevalent now, along with tumors, and other damaged cells that are harmful to our bodies. Whole great strides have been made in medicine, cancer causes still elude us. One of the possible explanations is cells that are in unnatural energy levels that disrupt natural cell formation and change other cell formations. One of these is melanoma, or a lesion on the skin that is cancerous. It begins with melanocytes, cells that make the skin pigment called melanin. It has increased in its severity in our population, and one of its causes has been tracked to the sun's harmful rays. By excessive exposure to the sun and successive cycles of tanning persons are more susceptible to getting melanoma through skin damage. A melanocyte is a pigment producing cell in the skin, hair and eye that determines color. The pigment that melanocytes produces is called melanin. When these melanocytes have their energy levels increased, such as taking in UV light from the sun, they can become damaged. They go into a different energy state, [symbol] E, or a higher level than ground state. In living organisms, in which the normal chemical reactions are based upon [symbol] E levels, this can produce cells that are “damaged”, and form more “wrong” chemical reactions, or produce cancerous cells. Since their cells (melanoma cells) show up and are detected by NMR, they have spins of the nucleus that are different from normal cells. By applying a swab of water to the local area where the melanoma cells are the cancerous cells, through a period of time, would interact with the water molecules and eventually turn back into “normal” non-cancerous cells by lowering of their energy states back to [symbol] E.

The nucleus with its protons, and possibly neutrons, is surrounded by the electron cloud. The description of a cloud is used because the electrons, as are the quarks, are in motion and the appearance would be of a cloud surrounding an object. In fact, the position of the electron is statistically unsure, so that we are not really positive where it might be at any given moment. The theoretical computations indicate it moves at the speed of light in a vacuum, but can move faster or slower depending upon the medium it is traveling in. Another particle, or wave, is the photon, and is a quantum of the electromagnetic field, and travels at the speed of light, and is usually associated with light, the light we see. When an electron is raised to another quantum energy level, and then loses this energy to a lower shell, it gives or emits a photon. This makes sense since the interaction with the nucleus must account for the change in the velocity of the electron being at a further distance from the nucleus and then changing back to a lower “orbit” (energy state). To keep the energy “balanced” so that the atom is back in the [symbol] E state, a unit of energy equal to the charge must be gotten rid of, and that is the emission of the photon.

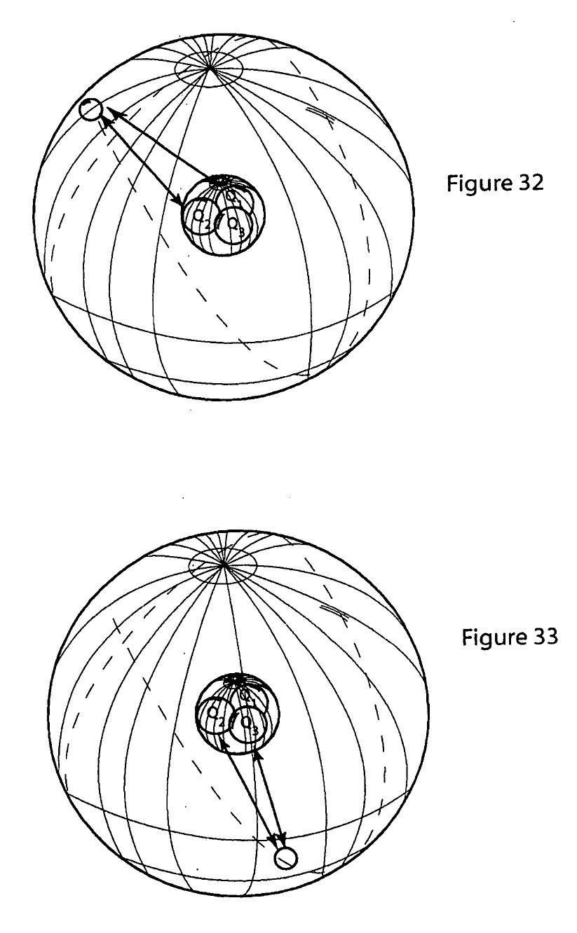

The interaction of a charge moving creates a magnetic field effect, and the changing of a magnetic field causes electrons to move. When an electron moves in “orbit”around a nucleus, the quarks must “adjust” themselves to the new location of the electron because different forces are reacting on them individually and one a whole. For example in FIG. 32, which represents S¹, a state 1, E⁻(electron) is closest to Q₂, so that the strongest interaction is with it individually. The next strongest interaction is with Q₁, while Q₃ is shielded. This gives arise to the electrical field E₁ from the electrical gradient attraction between the quarks, their position, and the electrons. Each of the quarks are interacting with one another, and try to adjust themselves to the position of e¹. This causes Q₁ and Q₂ to rotate from the force, but another force tries to keep them as they were. Each reaction has an opposite but equal reaction. This resistance to change and the resulting field is the magnetic field, and because the way the quarks are assembled into the proton acts at a right angle to where the electron is due to the change in the angular momentum.

However, electron has now traveled to a new position, S², or state 2, and causes the change in effects whereby the Q₃ is closest and has the maximum electric field gradient, Q₂ is the next, and Q₁ is shielded by the other two quarks. Q₂ is also trying to stop changing because it is not under the direct influence of e¹, however, its strong nuclear force with the other two quarks is still influencing its spin. Furthermore, to balance these forces of change, other, smaller particles or forces, could be exchanged between the different quarks to keep the total momentum of the combined particles in the same general area. These particles would have to be very short lived, travel very short distances, and travel faster than light, because of the change in location of the electron with regards to the three quarks. All this time, the quarks are trying to keep the spin, the angular momentum, the same while the electrical field is changing at the speed of light, therefore another field must arise to try and keep things the same, and we call this the magnetic field. That is why a moving magnetic field causes an electric field, that is, an electron to move and why a moving electric field causes a magnetic field.

Deuterium is also called heavy hydrogen, and it is a stable isotope of hydrogen. The nucleus of deuterium contains one proton and one neutron, whereas a normal hydrogen has just one proton and no neutrons. It occurs in nature in about 1 in 6500. The chemical symbol ²H identifies deuterium. Deuterium behaves basically chemically likes ordinary hydrogen, but the reactions occur slower. From the Wikipedia, the Free Encyclopedia, on the worldwide web@ en.wikipedia.org, herein incorporated by reference: “The existence of deuterium in stars is an important datum in cosmology. Stellar fusion destroys deuterium, and there are no known natural processes, other than the Big Bang nucleosynthesis, which produces deuterium. Thus it is one of the arguments in favor of the Big Bang theory over the steady state theory of the universe.” This is reasonable because as stated the universe is going from the individual atoms having higher energies to atoms having lower energies, to the [symbol] E state. Hydrogen would have started out in abundance in the deuterium state, but through the millennia and in-numerous reactions, would have decayed here on earth to the common, or normal hydrogen, that we experience today.

Definition of deuteron from the McGraw-Hill Encyclopedia of Physics, Second Edition, 1993, page 281, herein incorporated by reference: “Deuteron The nucleus of the atom of heavy hydrogen, ²H (deuterium). The deuteron d is composed of a proton and a neutron. As the simplest multinucleon nucleus, the deuteron has been the subject of extensive study. Its binding energy is 2.227 MeV; that is, this is the amount of energy which must be added to a deuteron for it to dissociate into a proton and a neutron. The accurate determination of its dissociation energy provides the means of calculating the mass of the neutron, the mass of the deuteron (2.014187 amu) and proton being known from other experiments.

The intrinsic angular momenta, or spins, of the proton and neutron combine to produce a deuteron spin of unity; hence, the deuteron obeys the type of quantum statistics that is known as Bose-Einstein statistics. The deuteron possesses a magnetic moment (0.857407 nuclear magnetron) and an electric quadrupole moment (2.738×10⁻²⁷cm²).

Deuterons are much used as projectiles in nuclear bombardment experiments, especially to produce (d, p), (d, n), and (d, x) reactions. In the first two reactions, because of the low binding energy of the deuteron, the neutron n or proton p is stripped from it and captured by the target nucleus. Meanwhile, the other half of the deuteron (that is, the proton or neutron) carries away the excess energy. The ¹H/²H abundance ratio in nature is 6700.”

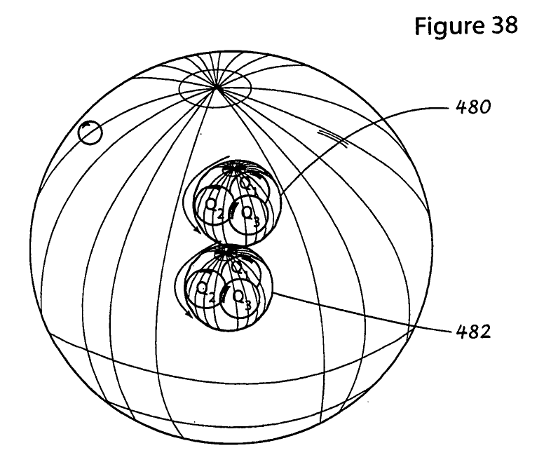

Heavy water processed by this method would have a percentage of the molecules realigned according to the method discussed herein. That is, the proton and neutron would not combine to produce a deuteron spin of unity, but would rather produce a nucleon that had the proton and neutron spinning in the same direction as that of one another, as seen in FIG. 38, or possibly have an electron's spin aligned with that of a proton, while the neutron remains the same. In FIG. 38, neutron 480 has a spin, or angular momentum, aligned with proton 482. Both of these possible states thus would make a deuteron, and hence the heavy water, much more reactive than normal. By the reprocessing of the water through several cycles would also yield a higher percentage of the aligned water.

It is also possible to create heavy water from normal water by this process. Since the water created by this process demonstrates unusual properties for reactiveness, it is apparent that it is easier for the newly created water to react by taking on an additional neutron. When water created by this process observed in beakers and glass tubes by sloshing the water about and observing its wetting properties it was noticed that the created water was definitely more sluggish than the normal distilled water. It “seemed” slower to drain back down the neck of the beakers and seemed to be observed to be “heavier” in nature. Since this newly created substance seems to be more reactive, it is possible that the neutron, in this case, a proton, is so spin aligned that it is “looking” for a partner to balance out its imbalance, to go to a lower energy state.

A lower energy state for the neutron is either to have the electron react and change its spin by giving off energy or have the spin counterbalanced by gaining a neutron that counterbalances the spin vector caused by the proton-electron combination.

One such way of creating heavy water would be the addition of an alpha-emitting radionuclide with beryllium powder. Such a mixture can be added to the water mixture as the distillation cycle is occurring, either in a powder form or encapsulated in a container. As the mixture naturally emits neutrons, and the bombardment of the material by microwaves would enhance this, the distilled water would take up a neutron and become heavy water. Since such a source also generates several hundred watts of heat it can also serve to preheat, or heat, the water for distillation. The reflector shield can have another layer that is lead that prevents any escapement of radioactive energy. As the material has a much greater boiling point than water and is also much heavier than water, it would not leave the distillation vessel. It is a further object of this invention to create heavy water.

Another embodiment of the invention is used for processing metals into super conductors, conductors with very greatly reduced resistance or semiconductors with reduced heating requirements at room temperature.

In this embodiment the fluid holding vessel 106 is made of high temperature ceramic, transparent to microwaves at the correct frequencies, for processing of metal. The material in fluid holding vessel 106 is preheated to the melting point of the substance, and then poured into the fluid holding vessel 106. Fluid holding vessel 106 can either be preheated or at room temperature. The fluid holding vessel 106 is then inserted into the microwave containment vessel 122 and microwave antenna 108 is inserted into the antenna chamber 123. This can be accomplished in many ways, such as microwave containment vessel 122 could have a bottom that flips up into place to hold fluid holding vessel 106 and has a snap in hole for the microwave antenna 108. Furthermore, the microwave reflector, or outer shell 144, can be a heating element along with being a reflective unit. This can be accomplished by having a heating coil built into the material of the microwave reflector 144 Also, fluid holding vessel 106 can have a heating element built into itself for keeping the material at a controlled temperature, or have channels running through its walls for the flowing of a material that would control the heat.

For instance, the fluid holding vessel 106 would be charged with an amount of copper at 2,000° F. It would have a lid 104 placed on it and then inserted into microwave containment vessel 122 and microwave antenna 108 would be inserted into the antenna chamber 123 and held in position. The microwave source 110 would be energized causing the microwaves to be injected into the fluid holding vessel 106 as described previously, further heating and aligning the particles. The particles of the substance, whether a metal, semiconductor material such as germanium, silicon, etc., would have its molecular structure aligned as previously described in the water example. It would not be necessary to bring the material to a gaseous state, but could be accomplished if so desired and might be advantageous to do so. The material could be subjected to as many cycles as desired for accomplishing the desired property.

Metals are one substance that allows electrons to flow through their formed structure more freely than other atoms, when the metals are in a solid state. Thus, they are good conductors of electricity, but even as good as they are, there still is resistance to the flow, or migration, of electrons through the solid structure. Metal as defined by the McGraw-Hill Concise Encyclopedia of Science and Technology, Third Edition, pg. 1151-1152, herein incorporated by reference, is:(“Metal. An electropositive chemical element. Physically, a metal atom in the ground state contains a partially filled band with an empty state close to an occupied state. Chemically, upon going into solution a metal atom releases an electron to become a positive ion. Consequently, in biotic systems metal atoms function prominently in ionic transport and electron exchange. In bulk a metal has a high melting point and a correspondingly high boiling temperature; except for mercury, metals are solid at standard conditions. Direct observation shows a metal to be relatively dense, malleable, ductile, cohesive, highly conductive both electrically and thermally, and lustrous. When crystals of the elements are classified along a scale from plastic to brittle, metals fall toward the plastic end. Furthermore, molten metals mixed with each other over wide ranges of proportions form, upon slowly cooling, homogeneous close-packed crystals. In contrast, a metal mixed with a nonmetal completely combines into a homogeneous crystal only in one or a few discrete stoichiometric proportions.”

Definition of electrical resistance from McGraw-Hill Concise Encyclopedia of Science and Technology, Seventh Edition, 1992, page 662, herein incorporated by reference: “Electrical resistance That property of an electrically conductive material that causes a portion of the energy of an electric current flowing in a circuit to be converted into heat. In 1771 A. Henley showed that current I flowing in a wire produced heat, but it was not until 1840 that J.P. Joule determined that the rate of conversion of electrical energy into heat in a conductor, that is, power dissipation H/t, could be expressed by the relation given in notation (1)
H/t∝I²R (1)

The day-today determination of resistance R by measuring the rate of heat dissipation is not practical. However, this rate of energy conversion is also VI, where V is the voltage drop across the element in question and I the current through the element, as in Eq. (2), from which the more conventional relationship
H/t∝I²R=VI (2)
implied by Ohm's law, Eq. (3), is apparent.”
R=V/I (3)

Definition of electrical resistivity from McGraw-Hill Concise Encyclopedia of Science and Technology, Seventh Edition, 1992, pages 662-663, herein incorporated by reference: “Electrical resistivity The electrical resistance offered by a homogeneous unit cube of material to the flow of a direct current of uniform density between opposite faces of the cube. Also called specific resistance, it is an intrinsic, bulk (not thin-film) property of a material. Resistivity is usually determined by calculation from the measurement of electrical resistance of samples having a known length and uniform cross section according to the following equation, where p is the resistivity, R is the measured resistance, A the cross-sectional area, and I the length. In the mks system (SI), the unit of resistivity is the ohmmeter. Therefore, in the equation below, resistance is expressed in ohms, and the sample dimensions in meters.
p=RA/1

The room temperature resistivity of pure metals extends from approximately 1.5×10⁻⁸ ohmmeter for silver, the best conductor, to 135×10⁻⁸ohmmeter for manganese, the poorest pure metallic conductor. Most metallic alloys also fall within the same range. Insulators have resistivities within the approximate range of 10⁻⁸ to 10¹⁶ ohmmeters. The resistivity of semiconductor materials, such as silicon and germanium depends not only on the basic material gut to a considerable extent on the type and amount of impurities in the base material. Large variations result from small changes in composition, particularly at very low concentrations of impurities. Values typically range from 10⁻⁴ to 10⁵ ohm-meters.

The temperature coefficients (changes with temperature) of resistivity of pure metallic conductors are positive. Resistivity increases by about 0.4%/K at room temperature and is nearly proportional to the absolute temperature over wide temperature ranges. As the temperature is decreased toward absolute zero, resistivity decreases to a very low residual value for some metals. The resistivity of other metals abruptly changes to zero at some temperature above absolute zero, and they become superconductors.

Metals and some semiconductors in particular, exhibit a change in resistivity when placed in a magnetic field. Theoretical relations to explain the observed phenomena have not been well developed.

Definition of conductivity from McGraw-Hill Concise Encyclopedia of Science and Technology, Seventh Edition, 1992, pages 456-457, herein incorporated by reference: “Conductivity A measure of the ability of a material to conduct electric current. It is the reciprocal of resistivity. Conductivity is commonly expressed as siemens (mhos) per meter, since the unit of resistivity is the ohmmeter. The conductivity of metallic elements varies inversely with absolute temperature over the normal range of temperatures, but at temperatures approaching absolute zero the imperfections and impurities in the lattice structure of a material make the relationship more complicated.

The conductivity associated with conduction electrons in a semiconductor is known as n-type conductivity; that associated with the holes in an impurity semiconductor (equivalent to positive charges) is known as p-type conductivity.”

Definition of semiconductor from McGraw-Hill Encyclopedia of Physics, Second Edition, 1991, pages 1269-1270, herein incorporated by reference: “Semiconductor A solid crystalline material whose electrical conductivity is intermediate between that of a metal and an insulator. Semiconductors exhibit conduction properties that may be temperature-dependent, permitting their use as thermistors (temperature-dependent resistors), or voltage-dependent, as in varistors. By making suitable contacts to a semiconductor or by making the material suitably inhomogeneous, electrical rectification and amplification can be obtained. Semiconductor devices, rectifiers, and transistors have replaced vacuum tubes almost completely in low-power electronics, making it possible to save volume and power consumption by orders of magnitude. In the form of integrated circuits, they are vital for complicated systems. The optical properties of a semiconductor are important for the understanding and the application of the material. Photodiodes, photoconductive detectors of radiation, injection lasers, light-emitting diodes, solar-energy conversion cells, and so forth are examples of the wide variety of optoelectronic devices.” (pg. 1269-1270)

Another alternate embodiment of the invention could have another valve on the exit port 112 (not shown) that could be controlled by the microprocessor 126. It would also have another entry port 118 (not shown) that would go to an external holding vessel 136 (not shown). Microprocessor 126 could then open the extra entry port 118 that leads to external holding vessel 136 that would contain a substance that is used to clean the fluid holding chamber 106 on a predetermined basis. The microprocessor 126 would notify the user that they should pour a substance into the external holding vessel when necessary. The microprocessor 126 would close entry port 116 and entry port 118 and exit port 112 and heat the liquid to a predetermined heating point to clean the fluid holding chamber 106. After a predetermined amount of time microprocessor 126 would open the entry port 116 and then after another predetermined time it would open exit port 152 to flush the system. After this cleansing it would begin the proper cycle of purifying the water again.

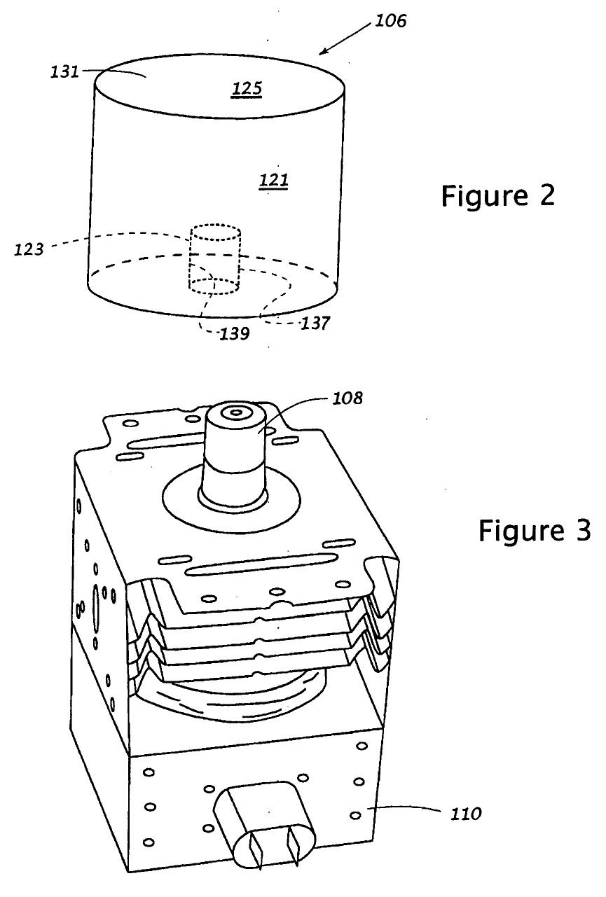

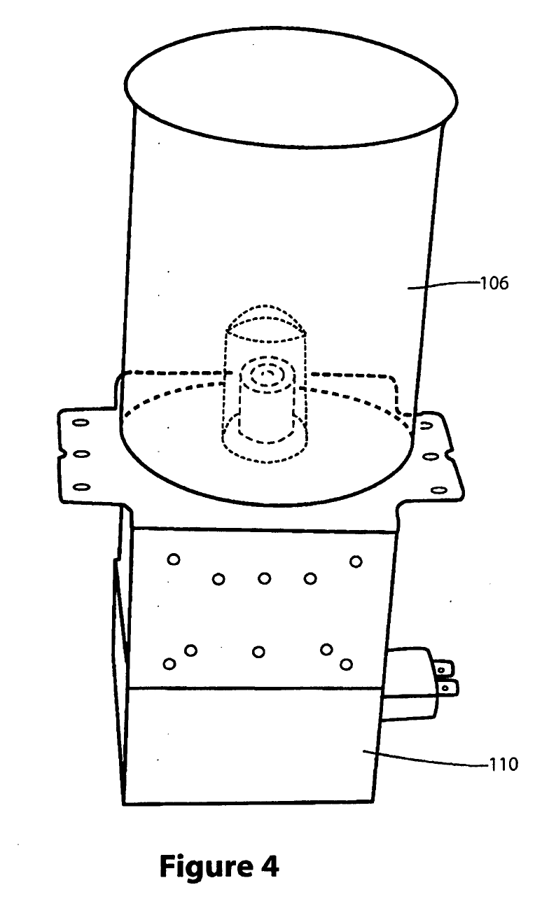

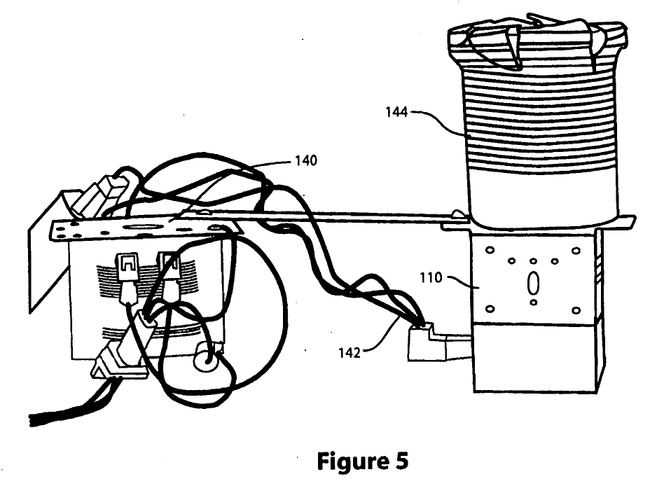

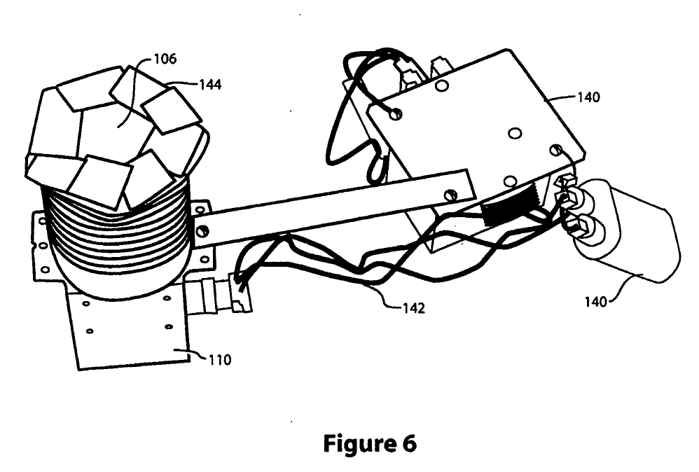

Another alternate embodiment of this invention could have the fluid containment vessel 106 shaped in the form of a sphere with a chamber formed therein rather than a cylinder shape as shown in FIG. 2 or FIG. 4. Any shape can be used that is suitable and is not constrained to the above mentioned shapes.

A problem with conductors and semiconductors is their resistance to the flow of electrons through the material that the electrons are traveling through. The basis for electricity is the electromagnetic field, specifically the electric field where there is a potential difference in the field. The electron wants to move, or flow away from the negative portion. Simply put, the electron wants to move away from the greatest amount of free electrons toward the least amount of free negative electrons. The least amount of free electrons could consist of “holes” where the electron usually is.

As the electron moves through the material it must physically travel from one location to another. Along its path it might bump into other electrons or pass nearby them. It might cause an electron to be ejected from an atom and then take its place. In its journey it meets resistance to it traveling along its path. This resistance is due to several factors, but the basic result is the same. The electron loses energy to its surroundings, with the energy loss to the surrounding material appearing as heat. The way the electron loses energy to the surrounding material appears as heat, but as stated previously, it is the coupling or transferring of energy between the original electron and the impacted electron, which causes the impacted electron to gain energy into its bond between it and its associated atom that it is bonded to. Too much energy gain, and the electron, and other nearby electrons, will break their bonds freely and “flow” by themselves. This is usually destructive to the surrounding material and is described as thermal run away. It also causes an increase in the background noise level for signals being processed by circuitry. The solution involves either additional cooling to remove the heat or a limit on the current, that is the flow, that is applied or put through a device, such as a wire, semiconductor, transistor, diode, resistor, etc.

The interaction between the flowing electron(s) and the surrounding material is caused by several factors, including material impurity, the type of material, the temperature of the material, etc. The resistance to the flow of the electrons through matter is measured in ohms/volume, or ohms/cm³, ohms/in³, etc. As an example, copper has a resistivity of 1.7·10−8Ωm while silver has a resistivity of 1.5·10⁻⁸Ωm. The resistance of the electron flow depends upon the temperature of the material, the cross sectional area of the material, and the length or distance the electron must travel. The longer the distance, the more resistance, as it must interact with more atoms. A larger cross sectional allows more electrons to travel through a material without interacting, thus it has more of a capacity to allow more electrons to flow.

With the material of a conductor or semiconductor treated with a method of this invention, the material would allow a greater amount of electrons to flow and to flow at a faster speed through the material without generating as much heat. The explanation for this is as follows.

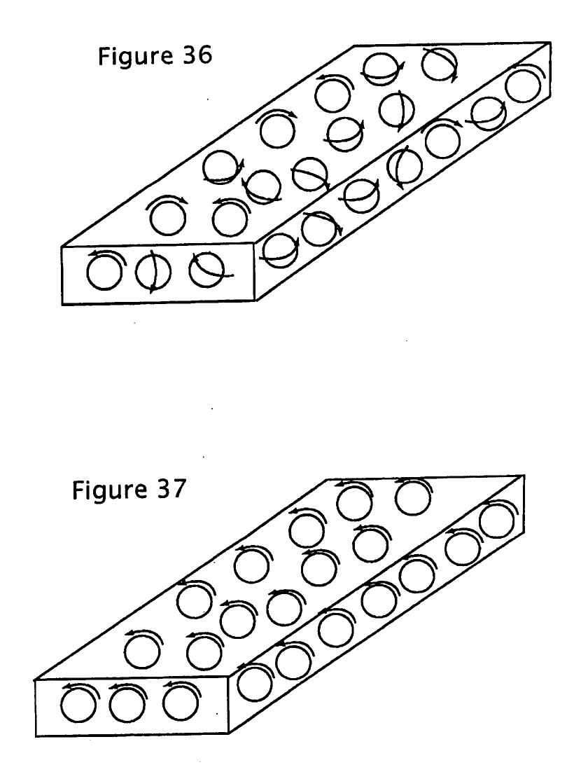

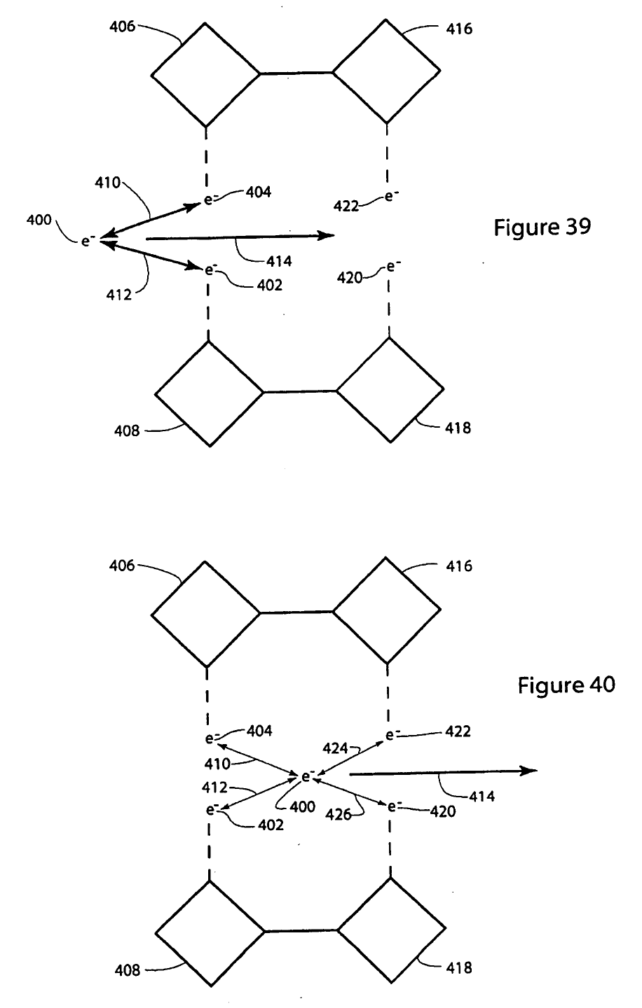

The initial electron has a negative charge, and along with this charge, being a free electron, has speed, velocity, direction, and rotation, or spin direction. The electron is going to travel toward a direction that attracts it the most, because of the electromagnetic field, and offers the least resistance to its path. It could be compared to a ball rolling down a hill. It rolls down because of gravity. It is trying to reduce its energy by being at the lowest level of energy. As it rolls down it bumps into other objects, and these objects deflect it and take energy away from it by reducing its speed. The ball keeps rolling if it does not encounter a ball big enough to stop it. If a ball hits an object that was spinning downhill, the ball would pick up more energy and travel faster. If the ball hits an object spinning uphill, then the spinning object is going to take away energy from the ball and impede its process. The same analogy applies to an electron traveling through matter. The matter it is traveling through has it electrons, spins, nucleons, quarks, etc. arranged in as statistically random arrangement, as no external arrangement has been forced upon the matrix of the material. Thus, as the electron traverses the matter it is traveling through it encounters random oriented spin fields locally. As the matter formed was heated and then allowed to be cooled back into a solid form again there is no local or global orientation to the atomic matrix, as seen in FIG. 36. By heating the material to a liquid or gaseous phase and then allowing it to solidify using the invention here in described creates matter that has the spins, bonds, nucleons, electrons, etc. oriented in a coherent direction as seen in FIG. 37. As long as the electron travels, as illustrated in FIG. 39, in the direction of the aligned spin, its resistance to travel can be greatly reduced, even to the point that a conductor will become a super conductor at normal temperatures. This takes into account that the injected spin of the electron is oriented with the same spin as the matter it is traveling in. As the electron 400 is first approaching another electron 402 its repulsion to the electric field charge 412 of the stationary electron 402 slows the electron 400 down. The other stationary electron 404 also contributes a repulsion due to its electric field 410. However the electric fields cancel each other out in regard to a vertical deflection from its path 414. After the electron 400 has passed stationary electrons 402 and 404, their electric fields 410 and 412 are still repulsive toward electron 400, however, their repulsion now accelerates, or thrusts electron 400 along its direction 414. At the same time electron 400 is repulsed by electrons 420 and 422 and electron fields 424 and 426. These repulsions cancel out the “pushing” electron 400 is receiving from electrons 404, 406 electric fields 410 and 412. Thus there is not net gain or loss of speed, therefore energy, of mobile electron 400 as it travels through the matrix. As stated before, a spinning, or moving, electrical charge creates a magnetic field. This magnetic field can couple with other magnetic fields and affect the energy of the system by either loss or gain of energy. A particle, if its magnetic field is affected, can have its momentum, spin, charge changed. This changing affects its energy level. When two particles approach each other with the same spin, they will not sufficiently alter the other particles spin. When the particles spins are different, one particle, through an interaction, will gain some momentum, or energy, and the other particle will lose it. This can alter both particles speeds and energy levels, and on the subatomic scale, the magnetic and electric fields. In the case of this invention, the mobile electron 400 spin is in the same direction and phase of bond electrons 402, 404, 406, and 408. When the mobile electron 400 approaches their fields, since the fields are matched as much as possible, there is little or no interaction of exchange of energy between them. Because the matter has been aligned in regards to the methods described herein, it will also have its crystalline or metallic arrangement of atoms in a more orderly fashion, allowing a better arrangement of its atoms. Furthermore, the new structure will have better heat conduction, better elasticity, and a much lower resistance to electrons traveling through its matter. Thus it is possible to make better semiconductor materials that will conduct electrons faster with a greatly reduced heat, metal conductors that can carry more amperage with much less resistance and heat, better materials for magnets, magnets that are smaller, lighter, and more powerful. These are merely a few examples of what nucleon-electron-bonding spin alignment can accomplish for material processing.

FIG. 30 is another embodiment of this invention. The material is flowed through material holding tube 428 in a continuous cycle. It would be continuously pumped into entry port 105 and flow out of exit port 108. Material holding tube 428 is continuously spiral wrapped around microwave antenna 108, which is supplied the energy by microwave source 110. The speed that the material flows can determined by the factors of size of pump, viscosity of material, diameter of interior of material holding tube 428, etc. Material holding tube 428 is made of material that is transparent to the microwave energy of antenna 108 for the supplied frequency of processing. Different materials will require different processing frequencies from microwave source 110. The furthermost exterior wall of material holding tube 428 can be coated with a thin film coating as described previously, or a microwave reflector 144 can be wrapped around the outside of the material holding tube 428, as shown in FIG. 30A. Because the material flows in the same direction of the EMF vector of the microwave field this embodiment also produces a material that has its nucleon-electron-spin aligned. It is an embodiment that can produce a product for processing of material for conductors or semiconductors. The material holding tube 428 can be made of high temperature ceramics that are transmissive to microwaves. As an example, copper can be preheated to its melting point of 2000° and then be caused to flow through material flowing tube 428 in a liquid state. As the copper is flowed through the microwave field emitted by antenna 108, it encounters a vector of EMF as shown in FIG. 10. As the flow is in a clockwise rotation around antenna 108 the material inside material flowing tube 428 encounters the same vector field 202 as shown in FIG. 10. Thus all of the material will try and align its spins to vector field 202, which is to the clockwise direction. Microwave field emitted from antenna 108 can further contribute energy to the material flowing as previously described and cause the material to become hotter with a greater capability of becoming further aligned. As the material exits the device the material can be allowed to cool according to the processing requirements, or further processed again, as described above. One method would be to flash cool the material as it exited the device to create a solid that was properly aligned.

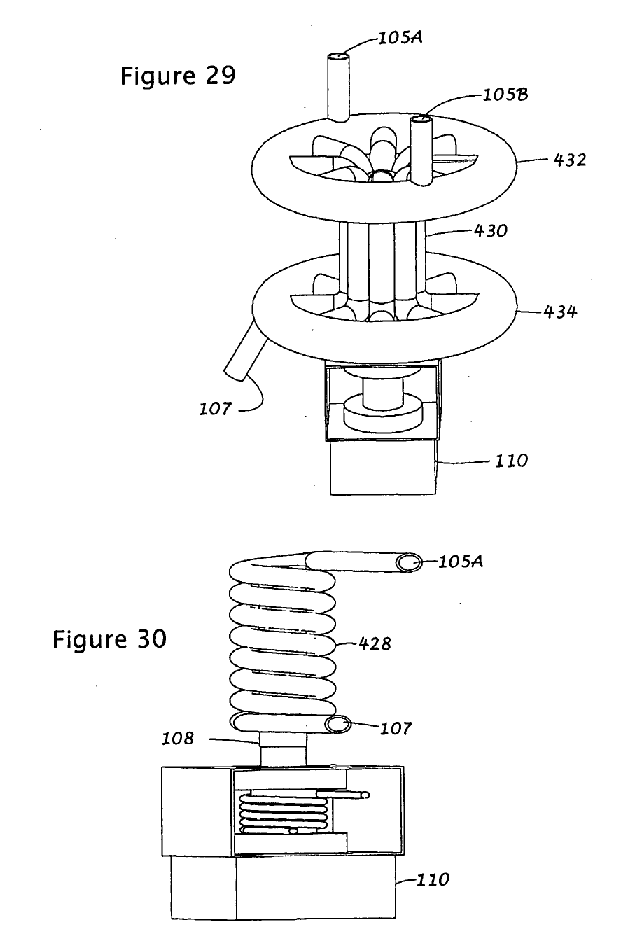

A further embodiment uses the figure as illustrated in FIG. 29. Referring to this figure material flows into input ports 105A, B. There also can be only one input port 105A. The material is then carried, or fills, in material holding vessel 432. This area, material holding vessel can either be heated naturally, or have a surrounding device to heat the area to keep the material inside at a predetermined temperature. The material flows from the material holding vessel into material flowing tubes 430 which surround antenna 108. As the material flows through the material flowing tubes 430 the energy from the microwaves permeate the material and further heating with alignment occurs, as described in previous embodiments. The rate of flow can be regulated as also described herein. The material flows into material holding vessel 434 that can either be heated by an external or internal device, same as material holding vessel 432. The material flowing tubes are in a radical vertical pattern surrounding antenna 108. The outermost part of the tubes can have a reflector on their surfaces or they can have a reflector shield radially surrounding them. The shield would act like a reflector and should surround the tubes and antenna alike to prevent any microwave energy from leaking out of the arrangement.

The microwave containment vessel 122 can comprise a microwave wave guide or microwave reflector 144 that comprises a layer of microwave reflective material on fluid holding vessel 106. In one embodiment fluid holding vessel 106 has an exterior surface 121 and an interior surface 125 and the layer of microwave reflective material is carried on the exterior surface 121 of the fluid holding vessel 106 but not on any surface of the antenna cavity 123 as this would prevent microwaves from the microwave antenna 108 from reaching the contents of the fluid holding vessel 106.

In addition to the microwave containment vessel 122 by itself as described above, this application teaches an apparatus which comprises a fluid holding vessel 106 having a chamber 123, the chamber 123 structure formed of a microwave transparent material as described above. The chamber 123 protrudes into a material holding cavity 131 (a “cavity” being an unfilled space within a mass and/or a space that is surrounded by something) of the fluid holding vessel 106. The apparatus may also include a microwave generator 110 with an antenna 108 connected to the microwave generator 110. The antenna 108 is positionable in the antenna chamber 123 and the antenna chamber 123 provides physical isolation between the antenna 108 and the material holding cavity 131 of the fluid holding vessel 106. In one embodiment the apparatus described immediately above comprises a heating device and the material holding cavity 131 of the containment vessel 122 contains material. The apparatus or device is capable of heating the material in the material holding cavity 131 of the containment vessel.

In another alternate embodiment of the invention a method for producing a distillate is contemplated. In this method for producing a distillate the apparatus for carrying out the acts of producing a distillate comprises a containment vessel 122 having a material holding cavity 131 (or material holding vessel 106) for containing material. The fluid holding vessel 106 of the microwave containment vessel 122 has a chamber 123. This chamber 123 provides physical isolation from the cavity 131 of the fluid holding vessel 106. The chamber 123, is formed of a microwave transparent material and the chamber 123 extends through a surface of the fluid holding vessel 106 and into the material holding cavity 131 of the fluid holding vessel 106. The apparatus further comprises a microwave generator 110, with an antenna 108 associated with the microwave generator 110. The antenna 108 is positionable in the chamber 123 of the fluid holding vessel 106. The apparatus also comprises a condensation coil 124 in communication with the fluid holding vessel 106. Distillate is collected in a holding vessel 120, which is in communication with the condensation coil 124.

In normal electrolysis of water, which occurs at room temperature, as illustrated and explained in the article, “Electrolysis of Water”, http://hyperphysics.phy.phv-astr.gsu.edu/hbase/thermo/electro.html, incorporated herein by reference, it requires approximately 237 kj. Normal electrolysis consists of two electrodes placed in a vessel filled with water, the electrodes attached to an electrical source that supplies the power. The hydrogen molecules are attracted to the negative electrode, while the oxygen molecules are attracted to the positive electrode. At the electrode sufficient energy is provided to overcome the energy of bonding, and the hydrogen is separated from the oxygen and forms hydrogen gas and oxygen gas, which being lighter than water, escapes as a gas from the surrounding water.

Much work has been done on HTE, or High Temperature Electrolysis, as outlined in the document “Advanced Nuclear Research,” Office of Nuclear Energy, Science and Technology, www.ne.doe.gov/hydrogen/hydrogenBG.html, herein incorporated by reference. The reasons are very simple and mundane. The higher the temperature of water, the more amount of energy the bonds and particles have acquired and the lesser the amount of energy then required to break the hydrogen-oxygen bond to form independent hydrogen and oxygen atom molecules. Atomic reactors typically run at very high temperatures so it is a relatively simple matter to use the cooling water, or water through a heat exchanger, to carry away the excess heat generated by the reactor. Through either a chemical process, electrochemical process, or electro process the steam is separated into the individual gases. However, while in principal it is easy, in practice there are several problems. While the energy needed is reduced with the increased temperatures, it increases the energy also required to cool the hot gases back to room temperatures. Furthermore, hot gases are dangerous and extremely volatile, leading to more caution and extreme handling procedures. In addition, the water used must be extremely pure. Water in a steam that approaches high temperatures require high pressures and become very caustic in regard to their interaction with other materials. Impurities can also become gases at these elevated temperatures causing further problems.

The water made from an embodiment of this invention has already had approximately 20 KJ of energy gained by its bonds and particles. Water requires approximately 237 KJ by conventional electrolysis methods to achieve the gases of hydrogen and oxygen. This means an additional 217 KJ would be required under normal circumstances, with the water already purified. However, as outlined and discussed before, this water has unusual qualities and properties from other distilled waters which can only be understood on the molecular level. As an example, two samples were prepared in the following way: in glass 1 an amount of distilled water, approximately 20 ml, was put into a glass along with 20 ml of cooking oil and 20 ml of liquid lecithin. It was thoroughly stirred and set aside. In glass 2 an approximate amount of 20 ml water produced by an embodiment herein described was also mixed with equal amounts of oil and lecithin. It also was stirred. In glass 2 it was noticed that the oil and water immediately began to merge together and become indistinguishable while in glass 1 the water and oil remained separate and distinct. After a period of approximately 5 minutes the ingredients in glass 1 were still separate and distinct, floating on top of one another in layers. In glass 2 all of the ingredients had merged together and become one homogeneous matter, gummy, a conglomeration of material that was indistinguishable from one another. The oil and water had mixed with the lecithin. The explanation for this is that the water had become more reactive than normal and would easily exchange its hydrogen atom, or atoms, easily. This state of water would then easily enter into a chemical reaction with other chemicals by exchanging a hydrogen atom for another atom. For this to happen, the new water must be in a different state of energy than normal water produced by distillation. What this means is that the new water will easily “give up” or exchange one or more of its hydrogens. This new water also has shown itself to be more reactive than normal steam at the same temperatures. The new water steam degrades plastic hosing while running through it that is rated for much higher temperatures and more caustic liquids. It was necessary to use stainless steel, polished on the interior, for the transportation and cooling of the new steam.

It is this lowering of the barrier of the new water to react that also allows it to separate hydrogen and oxygen more readily than normal water. By producing bonds with spins that are similarly

aligned. Spins that are rotationally similar in direction, the molecules will more readily lower their overall energies by reacting to create new substances, or in the case of electrolysis, lose their hydrogen bonds. Since the gain in energy of the molecules is due to molecular spin and not vibrational energy, the molecule stays the same temperature to the observer, but is much more reactive to its environment. It is this reactivity, the lowering of the barrier for reactions to take place, that makes the lower energy requirements of electrolysis applicable. This makes generation of hydrogen at home feasible.

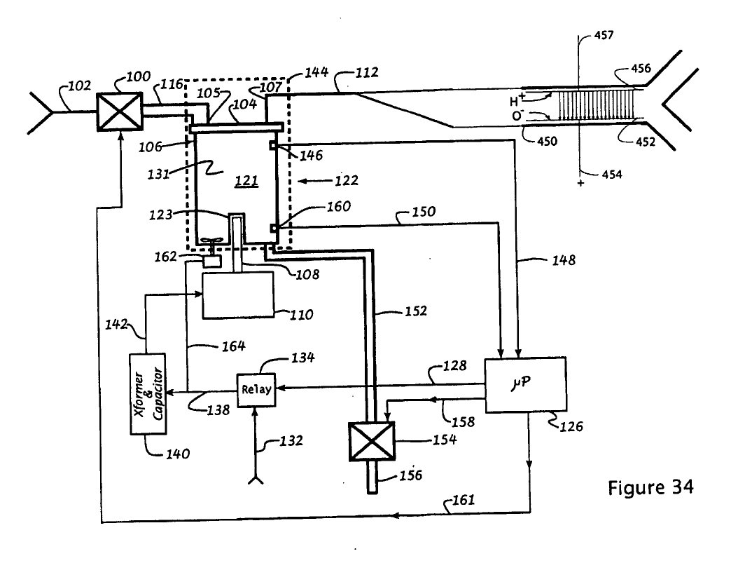

By using the apparatus and devices shown in FIGS. 31 and 34 hydrogen can be created accordingly to the embodiment described hereinafter. As in FIG. 1 and the description 100° C., and can be increased to a higher temperature and pressure as described by methods herein or other methods. This water has its reaction barrier lowered according to the microwave distillation methods described herein. While normal steam at 100° C. requires approximately an additional 217 KJ to react, this new water requires considerably less energy. While hydrogen gas was considered to be generated by the method herein, a lab setup was not available to test the quantity, nor were the tests repeated for fear of explosions. Also, the gas was not tested to be hydrogen, and could have been oxygen. More tests are required for the verification of the type and amounts of gases produced.

However, it is assumed that the energy requirements of this method have been reduced by a factor of two to three over other methods for producing hydrogen by electrolysis, making it a feasible product economically.

While the steam is flowing through pipe 112 it enters into the device illustrated in FIG. 31, which the tubing components 450, 464, and 466 are made of non metallic—non conducting material. A high temperature non conducting glass or ceramic is a candidate for this type of material. Tubing 450 has two electrodes 452, 456 contained in the space between its walls. In addition, these electrodes can be built into the tubing, or surround the tubing partially. These electrodes can be shaped like bars, plates, curved plates, etc. It might be advantageous to space them so that they are only slightly greater than the size of an oxygen atom by having a plurality of plates so spaced. When a steam molecule enters the area between electrodes 452, 456 it encounters a very strong electrical field. Electrode 456 has a negative potential applied to it while electrode 452 has a positive potential applied to it. The potential difference should be large enough so that when a water molecule in the steam state enters the electrical field the hydrogen is attracted towards the negative plate and the oxygen is attracted toward the positive plate. This tugging on the individual atoms of a molecule of steam will cause the bond to be broken between the hydrogen and oxygen. The hydrogen is further attracted towards tubing 458, which is conductive and also has a negative charge on it. Furthermore, the channel in which the hydrogen is attracted towards can be sized such that only a hydrogen atom can flow down it because the oxygen atom would be too large. The hydrogen continues to flow into tube 464, which is non conductive and into hydrogen storage container 468. The pressure from the steam and separated hydrogen further help push the hydrogen into collection vessel 468. The oxygen atom is further repelled by the negative charge on the tubing 458.

The oxygen atom, which also has been separated into a gas, is attracted toward the lower channel 460 which has a positive charge. This positive charge attracts the oxygen and repels the hydrogen molecules. Oxygen flows through non conductive tubing 466 and into collection vessel 470. In tubing's 458 channel the negative charge also helps to repel the oxygen and attract the hydrogen. The whole process is less energy consumptive and occurs more readily and because of the spin alignment of the electron-electron bonding-nucleon as previously described herein.

There are further methods that can be employed for the separation of hydrogen and oxygen utilizing the methods described herein. As an example, plates with holes sized approximately for the size of the molecules and with charges on the plates could also be used to separate and divert the molecules. A bio-chemical method can be constructed and used. A sulfur molecule along with the proper electrodes can be used to separate and generate hydrogen and oxygen.

The concept of cold fusion was brought to the limelight when a paper was introduced by two scientists, Martin Fleischmann and Stanley Pons, at a press conference at the University of Utah, in March 1989.

From the book “Nuclear Transmutation: The Reality of Cold Fusion” by Tadahiko Mizuno, 1998, herein incorporated by reference: “In the history of science there will be few peaks higher or stranger than the discovery of cold fusion. From that moment, a long-held notion was to be smashed forever: that atoms could not change their nuclear identities in near-room temperature reactions—reactions that were presumed to be chemical, not nuclear. Following the Fleischmann-Pons announcement, intense scientific investigations in electrochemistry uncovered a whole new class of low-temperature nuclear reactions. The astounding claims of Fleischmann and Pons had involved primarily large excess energy production, but also tritium formation and the appearance of low levels of neutrons. Later, investigators began to observe heavier elements and strange isotopes that were not present when their experiments began. Even “mainstream” cold fusion researchers, who focused on helium-production as the long sought “nuclear ash” of the cold fusion fire, found it difficult to accept the accelerating research on the low-energy transmutation of heavy elements.

It is now clear that Fleischmann and Pons discovered the mere tip of an iceberg within physics and chemistry. This new realm may eventually be called electro-nuclear reactions, so encompassing has it become. It was not merely a new “island” of physics that had come into view, but a whole new continent. Other names have been put forward for these alchemy-like reactions: “chemically assisted nuclear reactions” or LENRs (low energy nuclear reactions). Whatever the name, it seems that twentieth century physics took a wrong turn long ago by denying that such reactions could occur. There may be an error in the foundations of physics. Either that or quantum mechanicians will have to do very fancy footwork to explain what is happening in a provocative variety of cold fusion experiments.

It took a long time to verify the primary claim of Fleischmann and Pons, that an electrochemical cell with heavy water electrolyte and a palladium cathode could produce excess energy orders of magnitude beyond chemical reactions. Their announcement could have been a mistake—and the un-informed or those who rushed to judgment still think it is—but it was no mistake. Peer-reviewed and non-peer-reviewed scientific literature rule that out. “Cold fusion”-whatever its ultimate microphysical explanation turns out to be-accomplishes two “miracles”: 1) Highly positively charged nuclei of atoms which strongly repel each other are made to effect nuclear reactions at temperatures a million-fold cooler than in the cores of stars; and 2) When these reactions occur, they do not produce-deadly radiation.”

The basis for their claims is cold fusion, and can best be described as when two hydrogen atoms “fuse” into a helium atom, releasing heat. Normal hydrogen has 1 proton and 1 neutron, deuterium has 1 proton, 1 neutron, and 1 electron, while tritium has 1 proton, 2 neutrons, and 1 electron. The cold fusion process is thought to be able to take place in electrolysis vessels, such as U.S. Pat. No. 6,248,221, Davis et al., 2001, herein incorporated by reference for all purposes, using “conventional” heavy water and electrodes, even though the electrodes might vary in material composition. The basic premise is turning hydrogen into helium. From “Too Hot to Handle, The Race for Cold Fusion,” by Frank Close, Princeton University Press, copyright 1991, page 26, herein incorporated by reference for intents and purposes: “The payoff is not in the end products so much as in the energy that can be tapped. If this energy is converted into heat as the radiant particles pass through water, for instance, it can produce steam to drive a turbine and generate electricity.”

Fission is the process whereby the nuclei of heavy elements, such as uranium and plutonium fragment into smaller pieces, releasing energy. This is because the combined mass of the resultant particles are less than the initial mass, and according to Einstein's equation, the disappearance of mass must be energy. This also works with fusion because the combined particles of deuterium weigh less than the helium that is formed, and thus energy must be accounted for, and that is the “release” of energy.

From “Too Hot to Handle-The Race for Cold Fusion”, page 27, “These energies in nuclear reactions are enormous compared to the amounts involved in chemical reactions. Atomic energies are written in units called eV, short for electron-volts, one electron-volt being the energy an electron gains when accelerated by a one volt potential. Energies released and absorbed in chemical processes are about 1 eV per atom. The nuclear processes liberate a million times more energy, which is measured in MeV for mega (million) eV.
D+⁶Li→⁴He+⁴He (1)
D+⁷Li→⁴He+⁴He+n (2)

In the first reaction above the neutron carries away 2.45 MeV of energy, while in the second the proton has 3 MeV. Another possibility is that the two deuterium nuclei combine to form helium−4; here again the mass of helium-4 is less than the combined masses of two deuterium nuclei and the ‘spare’ mass is manifested as electromagnetic radiation far beyond the visible spectrum and known as a gamma ray (denoted by γ). This gamma ray carries away 24 MeV of energy but this process is very rare, occurring some ten million times less frequently than the neutron or tritium production channels.

These neutron and tritium production processes occur about 50:50 and modem attempts to generate useful energy in fusion experiments have tended to use beams of deuterons for which these are the fusion products. If you can get hold of the rarer tritium you may liberate nearly 18 MeV through the reaction:
d(np)+³H (nnp)=⁴He(nnpp)+n
A problem—the problem in the attempts to fuse nuclei together and release their internal energy-is that all nuclei carry positive electrical charge. It is the attraction of opposite charges that holds the negatively charged electrons in the atomic periphery where they encircle the positively charged nucleus, but the corollary is that like charges repel; two protons, each one positively charged, repel one another. You want to force those nuclei together while nature is designed to prevent it.

At this point it must seem paradoxical that atomic nuclei containing several closely packed protons exist at all. This is even more astonishing when one realizes just how compact the nucleus is; for example, scale a typical atom up to the size of a football stadium and the nucleus will be smaller than the football. The key is that when protons are touching they feel a strong attractive force, more powerful than the electrical forces that are trying to force them apart. It is this ‘strong nuclear force’ that holds the nucleus together but protons only feel it when they are in close proximity; once apart they feel the electrical repulsion. It takes only a few thousands of eV (keV) to bring two nuclei together and if they fuse you get over a million eV (MeV) in return. In practice it is very difficult to get two such small nuclei to collide and fuse, in beams of billions most of them simply miss one another.

To make a useful fusion reactor needs high densities of the deuterium fuel and, it has been traditionally assumed, temperatures greater than those in the centre of the Sun so that fusions occur frequently enough that more energy is liberated than consumed. This is the approach on which most of the effort—and the money—has been spent in recent decades. Recently some people have been trying a different approach, seeing if they can change the nature of the atoms such that fusion can occur at a useful rate even at room temperature. The former, the world of the tokamaks—particle beams—and mega dollar budgets, may be termed ‘hot fusion’; the latter attempts to generate fusion at room temperature are known as ‘cold fusion’.

From “Excess Heat Why Cold Fusion Research Prevailed,” Second Edition, copyright 2002, page 277, herein incorporated by reference: “The atoms in a metal, or other material, are commonly arranged in the orderly rows and columns of a lattice. Lattice structure is studied in the specialty of condensed matter (solid state) physics. The electrolytic cell uses a palladium metal cathode that is composed of tiny domains each of which is a crystal with a lattice structure. It is in this structure of crystal domains, with their interfaces between domains, pressed together into a solid piece of metal that one looks for an understanding of the power source. One of the theorist's conclusions is that in a perfect lattice, with the atoms in their places, there would be no low energy nuclear behavior.”

Palladium atoms are relatively big and heavy. The particular way that atoms arrange themselves in the palladium crystal allows a small atom like that of deuterium to be added to the crystal's interstices. The deuterium atoms fit nicely among the larger atoms without disturbing them too much. Deuterium could be added, if one knew how, until there was almost one deuterium atom for each palladium atom (the loading ratio).”

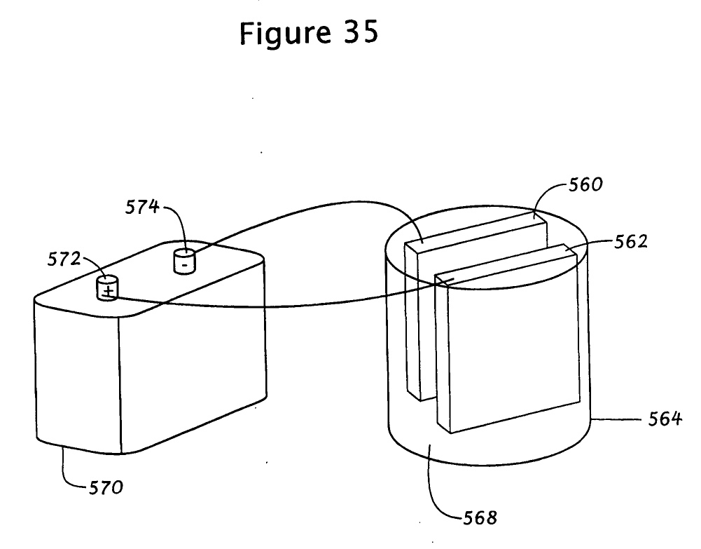

It is an object of this invention to teach embodiments of manufacturing palladium electrodes for cold fusion and the manufacturing, or modification, of heavy water to facilitate the reactions of cold fusion in accordance with the alignment of molecules to facilitate reactions. The cold fusion of Fleischmann and Pons occurs in a rather standard electrolysis set up, as in FIG. 35, however, the reactants are heavy water instead of normal water and the electrodes are a

palladium and platinum. While there is a question as to whether or not a reaction has taken place as they and others claim, it is of the general opinion of some scientists that such a reaction does occur given the right circumstances.

In a standard electrolysis setup battery 570 is hooked up to electrodes 560, 562 via terminals 572, 574. Terminal 572 is a positive terminal and can and is referred to as a cathode. Terminal 574 is a negative terminal, that is, electrons flow from its terminal toward the positive terminal, and is referred to as an anode. The action of a negative charge on electrode 560 and positive charge on electrode 562 causes a potential difference between them, that is an electric field. The value of that potential is dependent upon the distance between them, the value of the electric field, what they are made of, etc. The result is that molecules that have a positive charge, or potential, or polar alignment, are repulsed by electrode 562 and attracted by electrode 560. Particles with negative charges, potential, or polar alignment are repulsed by electrode 560 and attracted by electrode 562. These electrodes are contained in a vessel 564 that contains fluid, or material 568. These electrodes can take other shapes, such as cylinders, squares, circles, etc. The potential difference, if great enough, will cause the molecules to separate and breakup into their constituent parts, as with the generation of hydrogen and oxygen from water. Sometimes a catalyst must be added to help this main action to occur.

The generation of fusion is varied from this. One of the problems of cold fusion is repeatability and sustainability. In the Fleischman, Pons experiment it has been difficult, if not possible to repeat the original experiment. Much emphasis has been put on the manufacturing of the electrodes and materials they are construed out of. In regards to the palladium electrode, with is the negative electrode in Fleischmann, Pons, many studies and suppositions have been made as to whether the electrodes should be cast or extruded.

This patent discloses in a further embodiment a better method of making electrodes for a cold fusion device, along with a further embodiment for the reaction of cold fusion. As disclosed herein, it is possible to insert a material into material holding vessel 106 while in the liquid or molten state. In this case, the material is molten palladium, which melts at 1554.9° C. (or 2830.82° F.). To contain such a high temperature requires a high temperature vessel, and a zirconia ceramic is good candidate. It has a melting temperature of over 2770° C. The palladium is contained with material holding vessel 106, antenna 108 is positioned in cavity 137, and the microwave source 110 is energized.

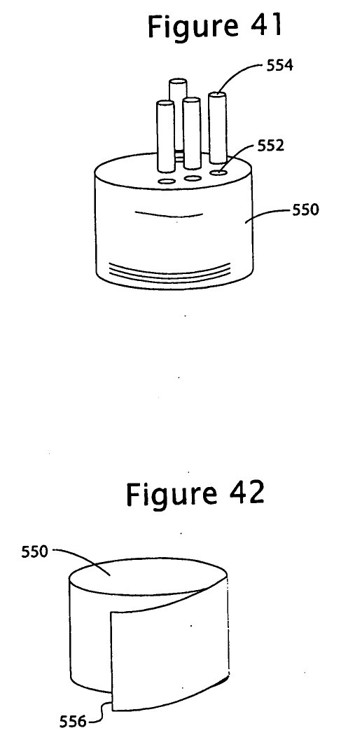

The microwave field from antenna 108 is transmitted into the material as described before and heats along with aligning the molecules and spin of the palladium. After an appropriate amount of time, microwave source 110 is stopped. The material in material holding vessel 108 is allowed to cool, or forced to cool, down below the melting temperature into a solid. This solid now has an aligned molecular structure with the alignment of the spins causing a regular lattice matrix that is of a higher bonding state than normal. The processed material is a solid in the form of a cylinder 550 seen in FIG. 41. This cylinder then has other cylinders 554 removed from its body. The removed cylinders have the same alignment as the master cylinder body 550. Another method would take the cylinder 550 and “unravel” it by peeling away layers as in FIG. 42 so that a roll 556 of material is created that also has the same spin alignment.

As in FIG. 35 the electrode 560 is of palladium that has been manufactured according to the alignment of this invention. The fluid 568 is heavy water manufactured according to this method and electrode 562 is a platinum or palladium electrode manufactured to this method, or electrode 562 can be manufactured according to conventional methods.

In the method of cold fusion according to this invention the heavy water hydrogen molecules are attracted to the electrode 560 while the oxygen molecules are attracted to the electrode 562. As the deuteron approaches the electrode 560 and is tugged away from the oxygen atom, the oxygen atom is repulsed by 560 and attracted by 562. The deuteron enters the lattice of the palladium metal and is taken up into the lattice. The initial attraction to a heavy water molecule is the electromagnetic forces of the potential difference between the plates 560 and 562. Once inside the metallic lattice the alignment of the spins and higher energy levels of the very large palladium nuclei start to exert their force. The palladium atoms are fixed or stationary while the deuteron atom is mobile. The deuteron possesses a magnetic moment that is affected by the magnetic moment of the fixed palladium nuclei. The palladium metal loads up with more hydrogen atoms in the form of deuterons and the inter-spatial areas between nuclei can find two or more deuterons inhabiting the space. The deuterons are forced together by the repulsive forces of the palladium nuclei, as they are repulsing the nuclei of the deuterons, which are mobile. When the deuterons are pushed or forced close enough they merge to become helium and release energy, which is absorbed by the palladium lattice. The merging is helped by the spin alignment because as the deuterons are more reactive than normal, wanting to lower their energy even greater than normal. With the palladium nuclei having spin alignment in one direction, it forces the first deuteron to alter and start changing its spin alignment. As the same space starts to become occupied by more deuterons, the next deuteron feels the exertion by the nuclei of the aligned palladium and of the aligned other deuteron. It reacts to the other deuteron and aligns itself by exchanging energy with the other deuteron. Both deuterons are being pulled together and interacting, so they are both susceptible to trying to lower their energy level. This can occur by forming helium of two protons, two neutrons, which has less than the combined masses of two deuterium nuclei, thus the “spare mass” is manifested by energy. Also, a molecule of tritium can be formed, which is 1 proton, 2 neutrons, and 1 electron so that 1 proton and 1 electron is released, that is, a normal hydrogen. Thus nuclear fusion occurs at room temperature.

Other modifications and variations to the invention will be apparent to those skilled in the art from the foregoing disclosure and teachings. Thus, while only certain embodiments of the invention have been specifically described herein, it will be apparent that numerous modifications may be made thereto without departing from the spirit and scope of the invention.

The scope of the invention should be determined by the embodiments, the claims and their legal equivalents, rather than by the examples given.

### DRAWINGS—REFERENCE NUMERALS

100 solenoid switch
102 input pipe
104 lid or cap
105 entry port
106 fluid holding vessel
107 exit port
108 microwave antenna
109 fluid holding vessel wall
110 microwave source or microwave generator
111 upper fluid cooling part
112 line 112L, 112R
113 line
114 level sensor
115 lower cooling fluid part
116 entry port
117 magnetron outer core shell
118 extra entry port
119 power connection
120 collection holding vessel
121 exterior surface
122 microwave containment vessel
123 antenna chamber
124 condensation coil
125 interior surface
126 microprocessor/controller or signal processor/determiner
127 upper magnetron magnet
128 signal line
129 lower magnetron magnet
130 signal line
131 material holding cavity
132 power line
133 fluid cooling coil
134 relay
136 external holding vessel
137 exterior surface of antenna chamber
138 power line
139 interior surface of antenna chamber
140 transformer & capacitor
142 signal line
144 microwave reflector or outer shell
146 second level sensor
148 signal line
150 first signal input
152 exit port
154 solenoid
156 waste water line
158 signal line
160 first level sensor
161 signal line
162 material stirrer
164 power line
200 EMF direction vector
202 E vector direction
204 steam inlet
206 steam outlet
208 water feed back line
209 water feed back port
210 water level
212 silver paint coating
214 copper paint coating
216 water level
218 overflow point
220 inlet steam (vapor) line
222 outlet steam (vapor) line
224 secondary vessel
300 hydrogen-oxygen bond spin
310 hydrogen-oxygen bond spin
320 hydrogen-oxygen bond spin
330 hydrogen-oxygen bond spin
340 angle between hydrogen bonds
342 air space
450 non conductive tubing
452 electrode
454 positive power connection
456 electrode
457 negative power connection
458 tubing
460 tubing
462 battery
464 non conductive tubing
466 non conductive tubing
468 hydrogen storage
470 oxygen storage
480 neutron
482 proton
550 master cylinder body
552 hole created by removal of cylinder
554 cylinder
556 roll of aligned material
560 electrode
562 electrode
564material holding vessel
568 fluid or material
570 battery
572 positive terminal
574 negative terminal

What is claimed is:

1. A molecular aligning material apparatus comprising:
a microwave transparent material holding vessel with a wall having an exterior surface and an interior surface defining a material holding cavity;
an antenna chamber having an antenna and formed in and providing physical isolation from the material holding vessel, the antenna chamber being transparent to microwave energy and protruding through the material holding vessel wall and the antenna chamber opening located substantially along and centered on an axis of the material holding cavity;
a microwave reflector on the exterior surface of the microwave transparent wall;
a material in the material holding cavity; and
a microwave source coupled to the microwave antenna that is placed in the antenna chamber of the microwave containment vessel.

2. The invention in accordance with claim 1 wherein the material in the material holding cavity is in a vaporous state.

3. The invention in accordance with claim 1 wherein the material in the material holding cavity is in a molten state.

4. A method of producing molecularly aligned water by microwave energy comprising the acts of:
providing a microwave containment vessel having an exterior surface and an interior surface defining a material holding cavity; an antenna chamber, the antenna chamber formed of a microwave energy transparent material, and extending through a surface of the microwave containment vessel and into the material holding cavity, and the antenna chamber opening is substantially located along and centered on an axis of the material holding cavity;
placing water into the material holding cavity;
providing a microwave source coupled to a microwave antenna that is placed in the antenna chamber of the microwave containment vessel;
providing a microwave reflector beyond the interior surface of the material holding cavity;
activating the microwave source to cause the antenna to emit microwave energy to heat the water in the material holding cavity;
continuing to heat the water in the material holding cavity to generate steam;
passing the steam through a condensation coil in communication with the containment vessel; and
cooling the steam to form the distillate.

5. A method of producing a molecular aligned material comprising the acts of:
providing a microwave containment vessel having a material holding cavity and an antenna chamber, the antenna chamber formed of a material that is substantially transparent to microwave energy, and extending through a surface of the microwave containment vessel and into the material holding cavity;
putting material into the holding cavity in the vapor state;
providing a microwave source coupled to a microwave antenna with the microwave antenna placed in the antenna chamber of the microwave containment vessel;
providing a microwave reflector beyond the interior surface of the material holding cavity;
activating the microwave source to cause the antenna to emit microwave energy to heat the material and aligning the molecular structure of the material in the material holding cavity;
continuing to cause the material to be heated and aligned for a predetermined amount of time;
cooling the material to form a solid with an aligned molecular structure.

6. A method as in claim 4 wherein the product of the distillate is a source of material for another pass through the method of claim 4 one or more times.

7. A method as in claim 5 wherein cooling the material causes only a portion of the molecular structure to be aligned.

8. A method as in claim 5 wherein cooling the material causes a portion of the plurality of molecules to be substantially aligned with one another.

9. A method as in claim 8 wherein the portion of the plurality of molecules to be substantially aligned with one another is less than 10%.

10. A method as in claim 5 wherein the portion of the molecules that are substantially aligned with one another is dependent upon the magnitude of the microwave energy supplied by the antenna.

11. A method is in claim 4 wherein the steam generated from the water is held in the material holding cavity for a predetermined amount of time before being allowed to pass to the condensation coil.

12. A method as in claim 4 wherein the steam generated is held in the material holding cavity until a predetermined pressure before being allowed to pass to the condensation coil.

13. A method as in claim 4 wherein the steam generated is held in the material holding cavity until a predetermined temperature before being allowed to pass to the condensation coil.

14. A method as in claim 4 wherein the distillate is water that has a purity of greater than 99.5%.

15. A method as in claim 4 wherein the distillate is water that has less than 1 ppm of other materials.

16. A claim as in claim 4 wherein the distillate is water and has a portion of the molecules that are substantially aligned with one another.

17. A method as in claim 15 wherein the distillate has a portion of the molecules that are substantially aligned with one another.

18. A method as in claim 4 wherein the microwave reflector is located on the exterior surface of the microwave containment vessel except for the antenna chamber.

19. A claim as in claim 4 wherein the microwave reflector substantially follows the contour of the exterior surface of the microwave containment vessel except for the antenna chamber.

20. A claim as in claim 4 wherein the microwave reflector is located within a distance of 2.54 millimeters of a substantial portion of the surface of the microwave containment vessel except for the antenna chamber.
